(19) United States
(12) Patent Application Publication
(10) Pub. No.: US 2009/0087267 A1
(43) Pub. Date: Apr. 2, 2009

(54) Pipeline-Laying Vessel

(75) Inventors: Robert Reinder Narold, Hoofddorp (NL); Cornelis van Zandwijk, Waddinxveen (NL)

Correspondence Address: HOFFMANN & BARON, LLP, 6900 JERICHO TURNPIKE, SYOSSET, NY, 11791, US

(73) Assignee: HEEREMA MARINE CONTRACTORS NEDERLAND B.V., Leiden (NL)

(21) Appl. No.: 12/279,101

(22) PCT Filed: Feb. 17, 2006
(86) PCT No.: PCT/NL2006/000082

§ 371 Date: Oct. 22, 2008

(51) Int. Cl. F16L 1/12

(52) U.S. Cl. 405/166

(57) ABSTRACT

The present invention relates to a pipeline-laying vessel (1) comprising: a hull assembly (8) for providing buoyancy to the pipeline-laying vessel (1); a tower assembly (2) extending upwardly from the hull assembly (8) for supporting a part of the pipeline (10) which is to be laid; a pipeline guiding assembly (60) provided at a position below the tower assembly (2) and configured to guide the pipeline (10). The pipeline guiding assembly (60) is coupled to the hull assembly (8) for transferring a force exerted by the pipeline (10) on the pipeline guiding assembly (60) to the hull assembly (8).

### FIELD OF THE INVENTION AND DESCRIPTION OF THE PRIOR ART

The present invention relates to a pipeline-laying vessel and to a method for laying a pipeline.

Pipeline-laying vessels and methods for laying a pipeline are known in the field of the art. In WO 01/07812, a pipeline-laying vessel is disclosed which comprises an upwardly extending tower, which defines a path down which a pipe passes as a pipeline is being laid. The pipeline-laying vessel further comprises a lower guide arrangement (or stinger) for guiding the pipeline after it has passed down the tower, the lower guide arrangement including a plurality of sets of guide rollers spaced apart along the path of the pipeline and defining the lateral limits of the path.

The tower is pivotably coupled to the hull of the vessel by means of hinges capable of varying the operational lay slope, which is defined by the longitudinal axis of the tower, from 90 to 120 degrees (from a vertical orientation to 30 degrees relative to a vertical axis). This pivoting movement is necessary to lay various pipe sizes in different sea depths, i.e. from shallow to deep water.

A disadvantage of the vessel of WO 01/07812 is that in use, forces and bending moments exerted by the pipeline on the lower guide arrangement are transferred to the tower. This requires a heavy construction of the tower and of the hinges.

These forces specifically occur when a main longitudinal axis of the pipeline-laying vessel is not parallel with the lay direction. The lay direction generally is parallel to the projected pipeline trajectory. Normally, pipeline-laying vessels are oriented with their main longitudinal axis parallel to the lay direction. However, a pipeline-laying vessel is generally sensitive for currents, waves and winds. When currents, waves and/or wind approach the vessel from a direction which makes a substantial angle with the main longitudinal axis of the vessel, it is difficult, in particular for a dynamic positioning system (DP-system), to maintain the position of the vessel.

In such circumstances, it may be required to rotate the pipeline-laying vessel about a vertical axis during pipeline laying in order to reduce forces from wind, waves and currents.

Depending on the orientation of the tower relative to a vertical axis, the pipeline may have to make a transition curve which curves away from a direction in which the tower extends to a direction in which the catenary curve of the pipeline extends. In order to make this transition curve the pipeline is to be laterally supported, preferably over a substantial distance.

If the angle of departure of the pipeline is relatively large, i.e. if a pipeline is laid at relatively small depths, the distance over which the pipeline is to be supported is relatively large. The angle of departure is the angle at which a main longitudinal axis of the pipeline extends relative to a vertical axis. Pipelines having a larger diameter require support over a longer distance than pipelines having a small diameter.

However, the construction of the lower guide arrangement of the vessel of WO 01/07812 is such that if large forces and/or bending moments are exerted by the pipeline on the lower guide arrangement, these forces and/or bending moments are transferred onto the tower. The tower and the hinges, by which the tower is connected to the hull of the vessel, must thus be very strong. This is a serious drawback of the vessel of WO 01/07812.

The forces and bending moments imparted by the lower guide arrangement on the tower increase with an increasing length of the lower guide arrangement. Therefore, in order to limit the occurring forces and bending moments on the tower, the length of the lower guide arrangement of WO 01/07812 must be limited. This is another disadvantage of the vessel of WO 01/07812. This effect is increased due to the fact that the lower guide arrangement widens and thus has an increasing surface area in a downward direction, when viewed from a side. The increasing surface area makes it increasingly sensitive to horizontal loads of waves and current.

### SUMMARY OF THE INVENTION

It is an object of the invention to provide a pipeline-laying vessel, which suffers less from at least one of the above mentioned drawbacks.

It is a further object of the invention to provide a pipeline-laying vessel in which forces exerted by a pipeline on the tower are substantially limited with respect to the known art.

At least one of the above mentioned objects is attained in a pipeline-laying vessel comprising:
a hull assembly for providing buoyancy to the pipeline-laying vessel;
a tower assembly extending upwardly from the hull assembly for supporting a part of a pipeline which is to be laid;
a pipeline guiding assembly provided at a position below the tower assembly and configured to guide the pipeline, wherein the pipeline guiding assembly is coupled to the hull assembly for transferring a force exerted by the pipeline on the pipeline guiding assembly to the hull assembly.

Due to the fact that the pipeline guiding assembly is disconnected from the tower assembly, only part of the radial forces generated by the pipeline transition curve reach the tower assembly. The greater part of the radial forces is transferred via the pipeline guiding assembly directly to the hull assembly.

The pipeline guiding device defines a passageway through which the pipeline extends during the laying thereof. The pipeline is allowed to move in a lateral direction, more or less freely in said passageway. The pipeline guiding device limits the curvature of the pipeline in the transition curve and thus limits strains in the wall of the pipeline to a required level.

The pipeline-laying vessel may be configured for J-lay. The tower assembly may comprise a pipe member support device configured for supporting a pipe member, which is to be connected to the free end of the pipeline, for instance by welding. The tower assembly defines a path down which a pipe is advanced as it is laid.

Alternatively, the pipeline-laying vessel may be configured for reel-lay, or a combination of reel-lay and J-lay.

The lower end of the tower assembly comprises a support device configured for supporting the free end of the pipeline.

The hull assembly may be of a semi-submersible type.

The pipeline may be a flowline, a steel catenary riser (SCR), a flexible riser or a different type of pipeline which is to be laid by a pipeline-laying vessel.

In one aspect of the invention, the pipeline guiding assembly defines a space in which the pipeline can move laterally, the space widening in a downward direction, in particular in the form of a trumpet-shape.

The widening space, in particular in the form of a trumpet-shape, advantageously supports the pipeline along a curvature in which the occurring strains are limited to a predetermined acceptable level.

In one aspect of the invention, the pipeline guiding assembly is provided at a distance below a lower end of the tower assembly.

Since the pipeline is to extend along a curvature, it is advantageous to support the pipeline not only at a start of said curvature, but also at at least one point along said curvature at a substantial distance from the start.

In one aspect of the invention, the pipeline guiding assembly comprises a plurality of support means spaced apart from one another in a substantially vertical direction, each support means being configured to receive a force exerted on it by the pipeline.

The spaced apart support means spread the load exerted by the pipeline on the guiding assembly over a number of points, thereby reducing peak loads on the pipeline.

In one aspect of the invention, each support means defines a respective aperture which substantially surrounds the path of the pipeline. The aperture advantageously limits the lateral movements of the pipeline at each support means and ensures support of the pipeline in substantially each direction.

In one aspect of the invention, the tower assembly is pivotably mounted relative to said hull assembly. This provides an advantage in that the inclination of the tower can be adjusted to a required departure angle of the pipeline or to a desired stress condition in the pipeline.

In one aspect of the invention, the pipeline-laying vessel further comprises a pipeline measuring device comprising a sensor, the pipeline measuring device being configured for measuring:
a departure angle at which the pipeline extends relative to a longitudinal axis of the pipeline guiding device of at least one point on the pipeline, and/or
a location of a point of the pipeline relative to a known point on the vessel.

Advantageously, an occurring strain in the pipeline can be determined from the at least one measurement during the laying. This allows an operator to safeguard that the pipeline does not move beyond a required lateral limit such, that a strain in the wall of the pipeline will exceed a predetermined limit.

In one aspect, the pipeline measuring device is configured to perform a measurement on a point on the pipeline at a lower end of the pipeline guiding assembly. At the lower end, the catenary to the seabed begins. Hence, this is a relevant region to perform the measurements.

In one aspect of the invention, the pipeline measuring device comprises a control unit comprising:
a first input for receiving departure angle data relating to an allowable departure angle of the pipeline and
a second input configured to receive an input signal from the sensor relating to the measured point, the control unit being configured to compare the signal with the allowable departure angle data and to generate an output signal on the basis of the comparison;
an output for outputting the output signal; and

a display means for displaying the output signal to an operator or a control means configured for controlling at least one parameter of the pipeline laying process on the basis of the output signal.

In one aspect of the invention, the pipeline measuring device comprises a control unit comprising:
a first input for receiving position data relating to an allowable position of the pipeline relative to a known point on the vessel and
a second input configured to receive an input signal from the sensor relating to the measured point, the control unit being configured to compare the signal with the allowable position data and to generate an output signal on the basis of the comparison;
an output for outputting the output signal; and

a display means for displaying the output signal to an operator or a control means configured for controlling at least one parameter of the pipeline laying process on the basis of the output signal.

Advantageously, an operator may receive a clear read-out of an occurring situation of the pipeline, allowing the operator to control the pipeline-laying operation on the basis of the read-out. When the departure angle exceeds the allowable limit, the output signal may alarm an operator. Alternatively, the output signal may be used to automatically control one or more parameters relating to the pipeline laying operation by a control system, such as the controlling the thrust of the vessel, the orientation of the vessel, the inclination of the tower and/or other parameters or a combination thereof.

In one aspect of the invention, the sensor is provided on an engagement member configured to be in contact with the pipeline, the engagement member configured to allow the pipeline to move relative to the engagement member in the direction of the main longitudinal axis of the pipeline.

This embodiment advantageously provides a direct measurement on the surface of the pipeline, avoiding an indirect measurement which may be difficult to perform in some circumstances, such as when the water is turbid.

In another aspect of the invention, the pipeline guiding assembly is movable relative to the hull assembly in a horizontal direction.

If the inclination angle of the tower assembly is changed, the pipeline guiding assembly can advantageously be moved horizontally in order to be positioned substantially in line with the longitudinal axis of the tower assembly.

In one aspect of the invention, the pipeline guiding assembly is movable relative to the hull assembly in a vertical direction. The pipeline guiding assembly can thus be moved to a position above the water-line, for maintenance.

In one aspect, the pipeline guiding assembly is pivotable relative to the hull assembly about a substantially horizontal axis, advantageously allowing the pipeline guide assembly to be positioned substantially coaxial with the longitudinal axis of the tower assembly.

In one aspect of the invention, the pipeline guiding assembly is movable away from the launching path in order to allow an in-line or add-on structure of the pipeline to pass by the pipeline guiding assembly. Advantageously, relatively large structures may be inserted into, or added onto, the pipeline without being hindered by the pipeline guiding assembly as the structure is moved downward.

The launching path is the trajectory that a pipeline may follow as it is lowered from the vessel. Since the pipeline guiding assembly allows for some lateral movement of the pipeline below the tower assembly, the launching path has a width coinciding with the lateral limits of the pipeline guiding assembly.

In one aspect of the invention, the pipeline guiding assembly is suspended from the pipeline-laying vessel by at least one elongate suspension member. This has proven to be a simple and effective way of securing the pipeline guiding assembly.

In one aspect of the invention, the pipeline guiding assembly comprises a cut-away section allowing the pipeline to be moved substantially laterally into and/or out of the space defined by the pipeline guiding assembly. The cut-away section advantageously allows the pipeline guiding assembly to be moved away from the pipeline, for instance when an in-line or add-on structure is to be moved by the pipeline guiding assembly.

In one aspect of the invention, the pipeline guiding assembly further comprises a door device, for opening and/or closing the cut-away section. After a pipeline is moved into the pipeline guiding assembly, the door may be closed, such that the pipeline is advantageously completely surrounded and supported in all directions.

In one aspect each of the support means is pivotably mounted to the hull assembly or to a support structure mounted to the hull section allowing each support means to be pivoted away from a central axis of the pipeline guiding assembly. When the support means are pivoted away from the pipeline, an in-line structure or add-on structure may easily be installed to the pipeline and lowered with the pipeline from the vessel.

The invention further relates to a pipeline-laying vessel configured for S-lay, the pipeline-laying vessel comprising a support structure which extends downward from the hull assembly, wherein a pipeline guiding assembly is fixed to a lower end of the support structure, the pipeline guiding device comprising a plurality of support means spaced apart along a central axis of the pipeline guiding device in the form of a trumpet-shape, the support means configured for supporting the pipeline in a lateral direction.

Advantageously, the pipeline guiding assembly may support the pipeline along a curvature which curves away from a vertical plane defined by the longitudinal axis of the S-lay vessel or, when the firing line is positioned off-centre, from a vertical plane parallel to this plane.

In S-lay, the free end of the pipeline is supported with its longitudinal axis oriented substantially horizontally. The pipe members are connected to the pipeline in a horizontal orientation. The support structure is generally fixed to the pipeline laying vessel and guides the pipeline from a horizontal direction to a, generally, vertical direction. The support structure is rigidly connected to the vessel. Hence, a distal end of the support structure defines a launch angle at which the pipeline is launched from the vessel. During operation, a required departure angle of the pipeline may differ from this launch angle, for instance due to the fact that the vessel has a different orientation than the lay direction. The pipeline guiding assembly may then guide the pipeline over a certain distance along a transition curve from the launch angle to the required departure angle.

The invention further relates to a method of laying a pipeline, comprising providing a pipeline-laying vessel comprising:
a hull assembly for providing buoyancy to the pipeline-laying vessel (1);
a tower assembly extending upwardly from the hull assembly (8) for supporting a part of the pipeline which is to be laid;
a pipeline guiding assembly provided at a position below the tower assembly and configured to guide the pipeline, wherein the pipeline guiding assembly is coupled to the hull assembly for transferring a force exerted by the pipeline on the pipeline guiding assembly to the hull assembly,

wherein during the laying of the pipeline, the pipeline is laterally supported by the pipeline guiding assembly.

During the laying of the pipeline, large forces on the tower assembly are avoided, thereby making the operation easier to perform.

In one aspect of the invention, during the laying of the pipeline the pipeline-laying vessel is rotated about a vertical axis relative to a lay direction, such that a longitudinal axis of the pipeline laying vessel extends at an angle to the lay direction.

In this orientation, the pipeline guiding assembly supports the pipeline along a three-dimensional transition curve in such a way, that strains in the wall of the pipeline are limited to a required level.

The invention further relates to a vessel for laying a pipeline, comprising:
a pipeline construction ramp provided on board the vessel for connecting respective pipe members to the pipeline;
a support structure for laterally supporting the pipeline as it is launched from the vessel;
a pipeline measuring system configured to determine an angle of the longitudinal axis relative to a vertical axis of a pipeline section extending downward from the pipeline laying vessel or configured to measure a location of a point on the pipeline section relative to a known point on the vessel.

In known vessels, the strains in the pipeline are monitored by measuring loads which the pipeline applies to the support means supporting the pipeline. The measuring of loads however is cumbersome, because the loads are measured under water with support means which are adapted to simultaneously support the pipeline and measure a force. These support means are rather complex and prone to wear and tear.

According to the invention, the monitoring of the pipeline is uncoupled from the supporting thereof, allowing the support means to have a simpler construction. Also, measuring an angle of the pipeline or a location of a point on the pipeline is generally simpler than measuring a force on a support means. This further simplifies the monitoring of the pipeline. The angle may be determined by measuring a location of at least one point on the pipeline section.

In one aspect of the invention, the pipeline measuring system comprises an engagement member which is configured to engage the pipeline section, the engagement member comprising at least one sensor for determining the pipeline angle, the engagement member configured to allow a downward movement of the pipeline relative to said engagement member.

A direct measurement on the surface of the pipeline is weatherproof and can also be performed in muddy water.

The invention is explained in more detail in the text, which follows with reference to the drawing, which shows a number of embodiments, which are given purely by way of non-limiting examples.

### BRIEF DESCRIPTION OF THE DRAWINGS

FIG. 1 shows a schematic side view of a pipeline-laying vessel according to the prior art;

FIG. 2 shows a side elevation view of a tower assembly of the pipeline-laying vessel according to the prior art;

FIG. 3 shows a front elevation view of a tower assembly of the pipeline-laying vessel according to the prior art;

FIG. 4a shows a schematic side view of a lower part of a tower assembly according to the prior art;

FIG. 4b shows a spatial arrangement of guide rollers in the tower assembly of FIGS. 1-3;

FIG. 5a shows a schematic side view of a pipeline-laying vessel;

FIG. 5b shows a top view of a pipeline-laying vessel;

FIG. 6 shows a schematic side view of the pipeline-laying vessel according to the invention;

FIG. 7 shows a top view of a guiding device according to the invention;

FIG. 8 shows a display of the measurement of the pipe position taken along the line 71 of FIG. 6;

FIG. 9 shows a schematic side view of another embodiment of the pipeline guiding assembly;

FIG. 10 shows a schematic side view of another embodiment of the pipeline guiding assembly;

FIG. 11 shows a schematic side view of a different embodiment of the pipeline guiding assembly;

FIG. 12 shows a schematic top view of another embodiment of the pipeline guiding assembly;

FIG. 13 shows a schematic top view of another embodiment of the pipeline guiding assembly;

FIG. 14 shows a schematic side view of another embodiment of the pipeline guiding assembly;

FIG. 15 shows a schematic side view of another embodiment of the pipeline guiding assembly;

FIGS. 16a, 16b and 16c show schematic side views of a measuring device according to the invention;

FIG. 17 shows a schematic top view of a different pipeline-laying vessel according to the invention; and

FIG. 18 shows a schematic side view of a pipeline-laying vessel according tot he invention.

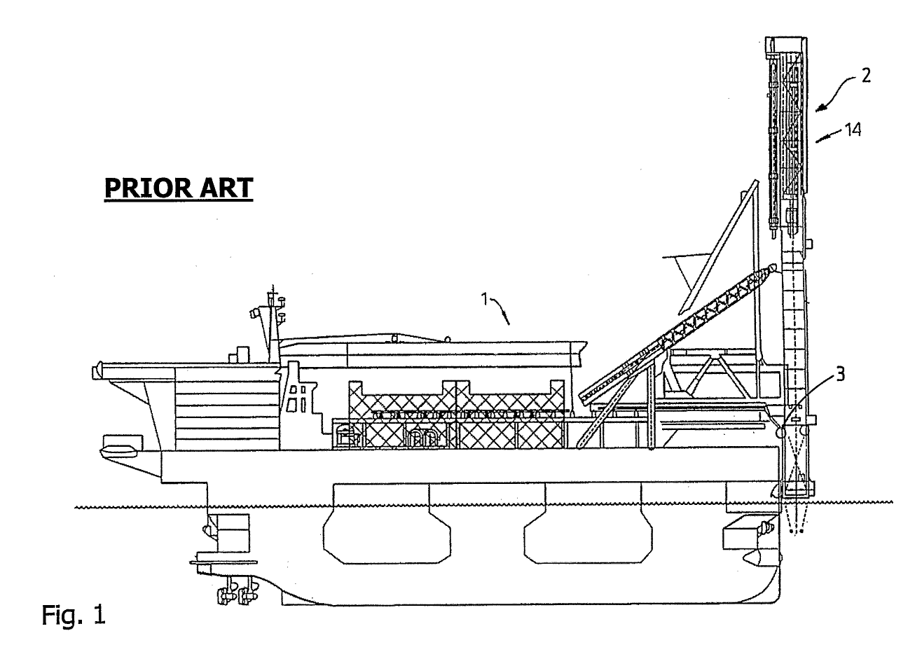

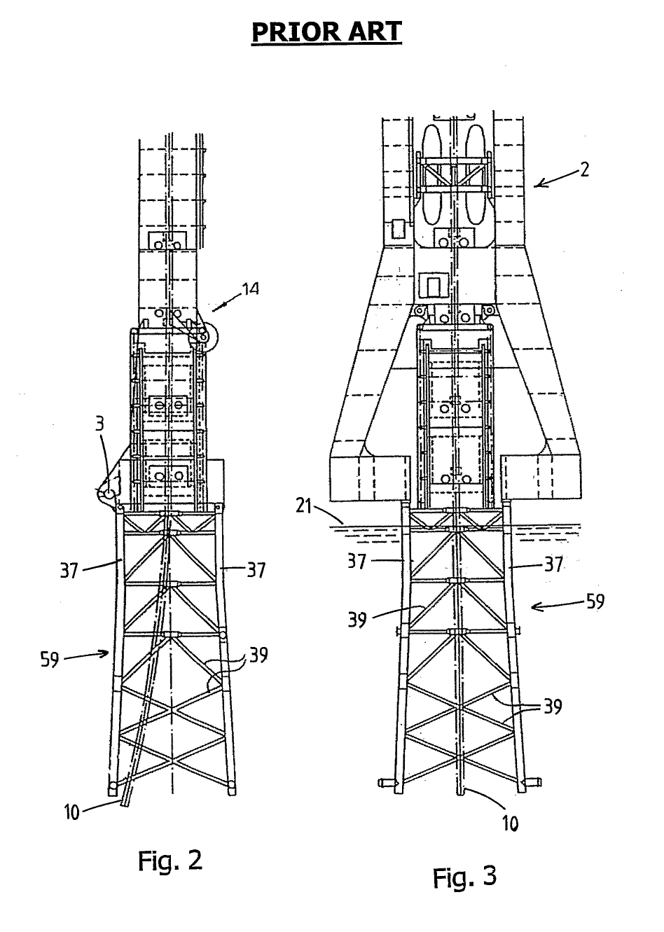

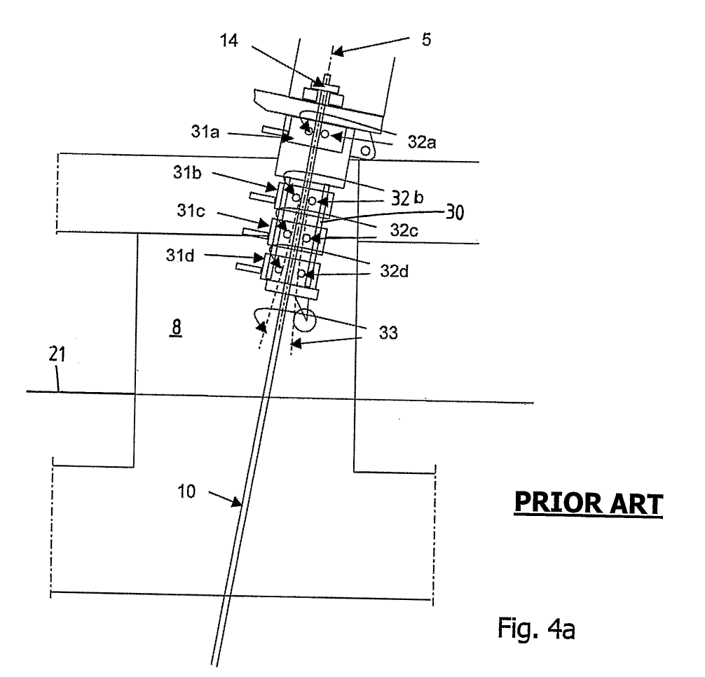

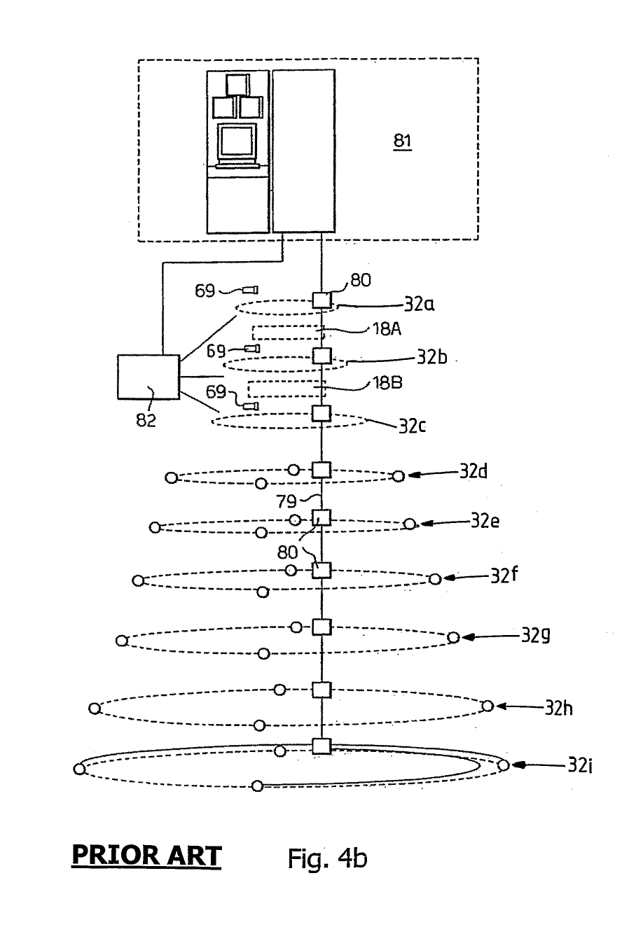

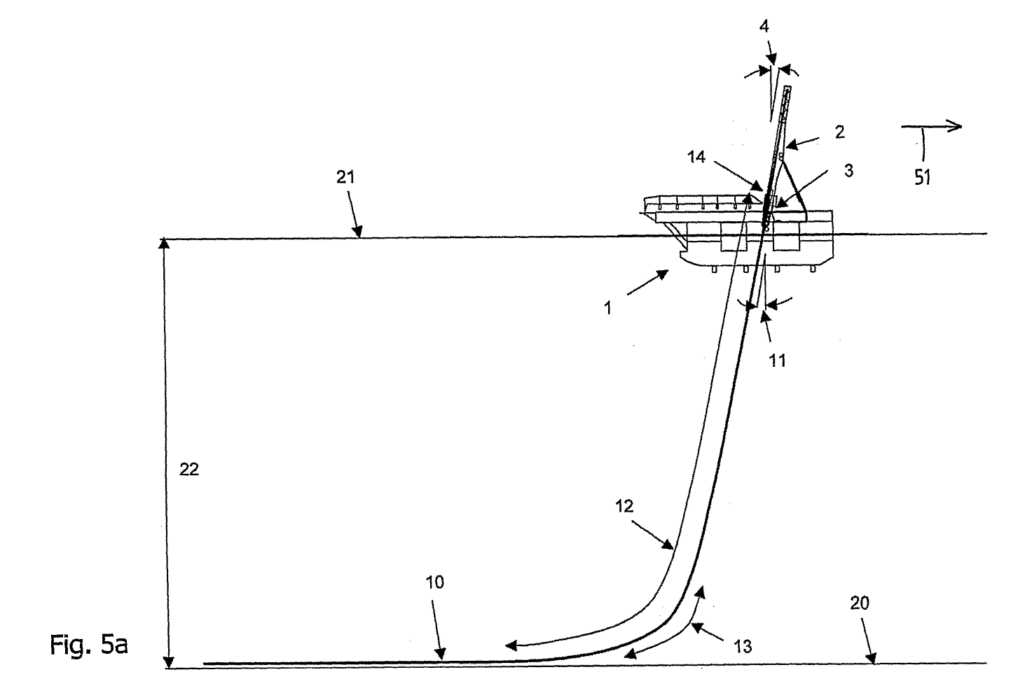

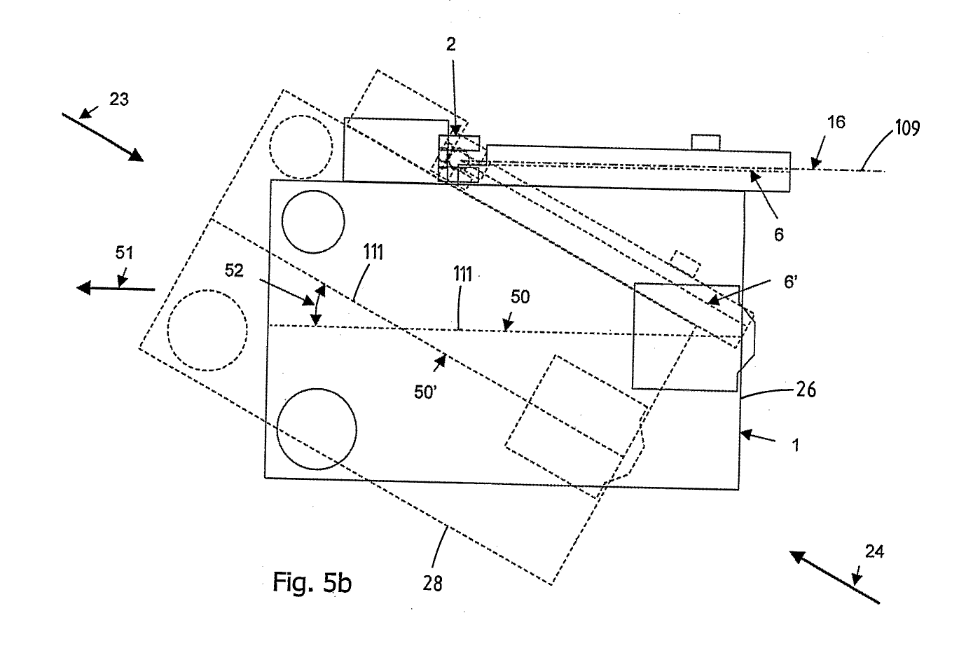

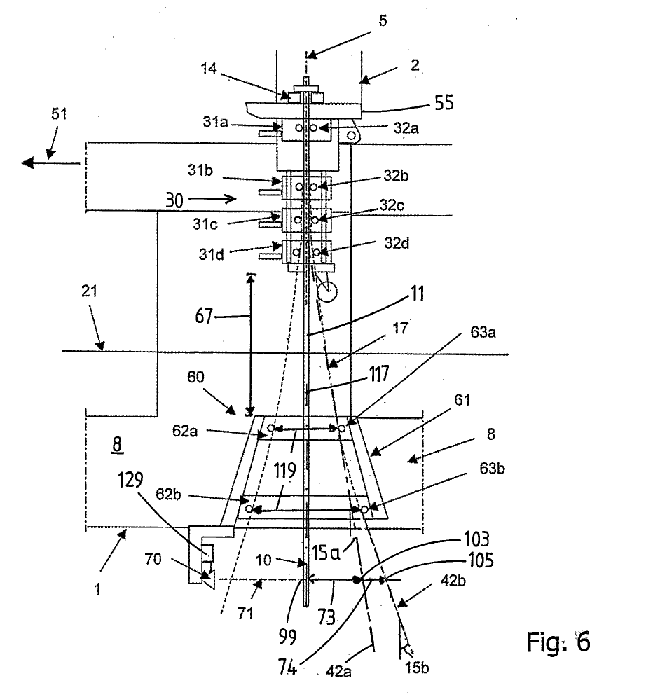

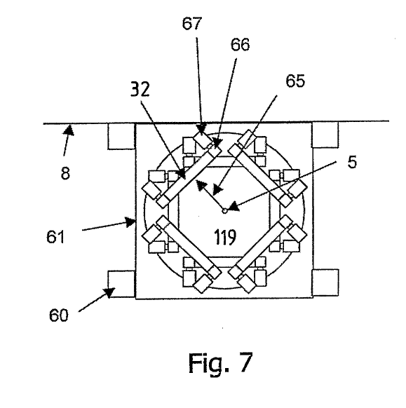

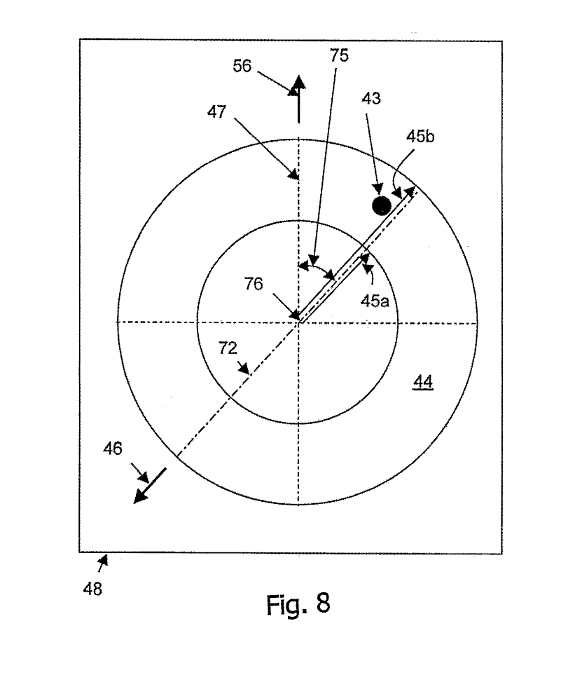

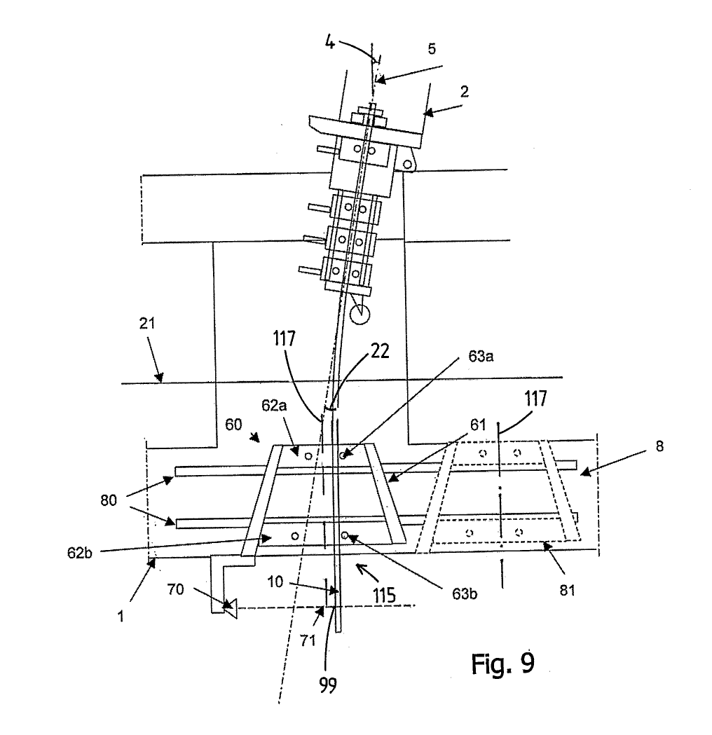

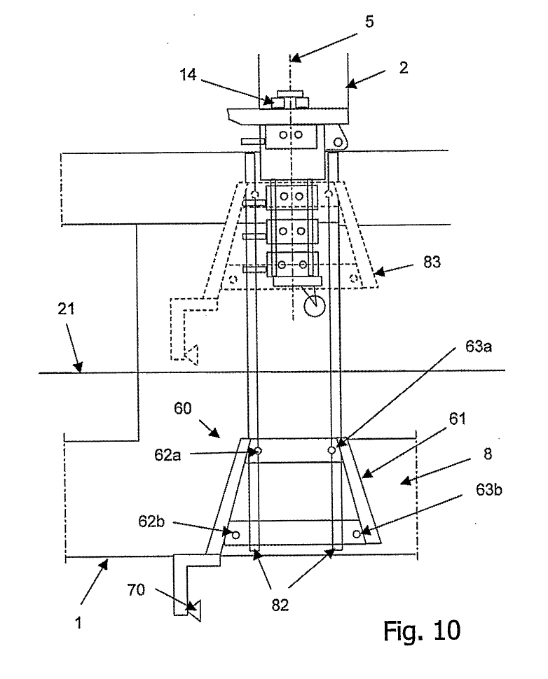

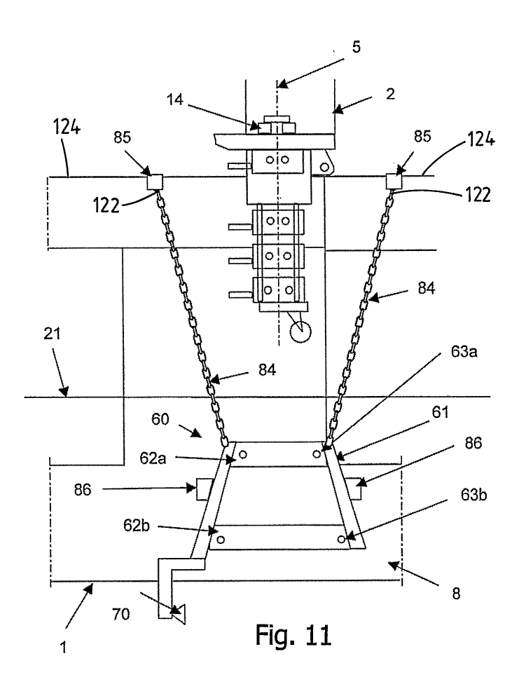

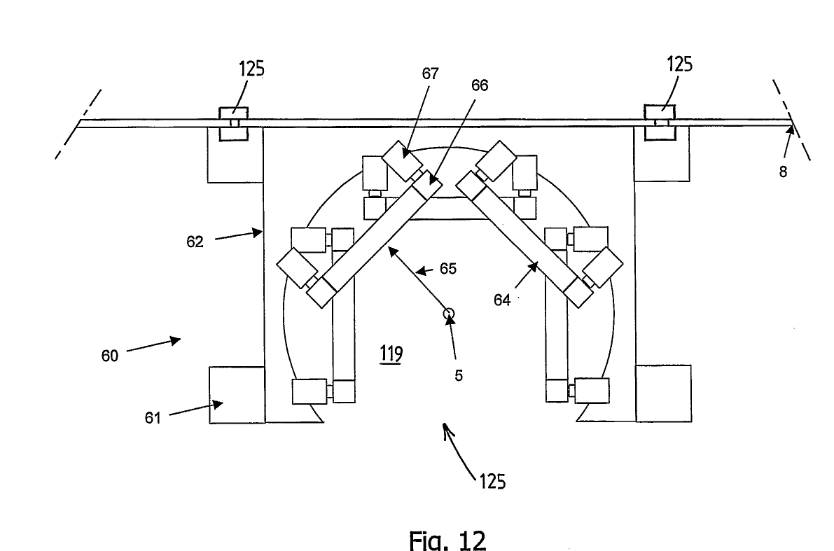

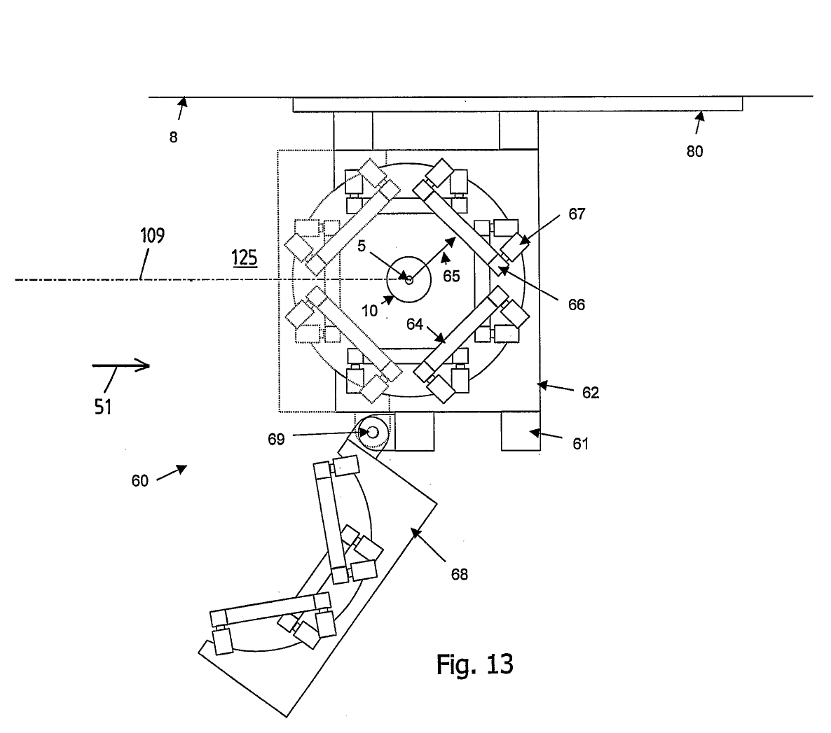

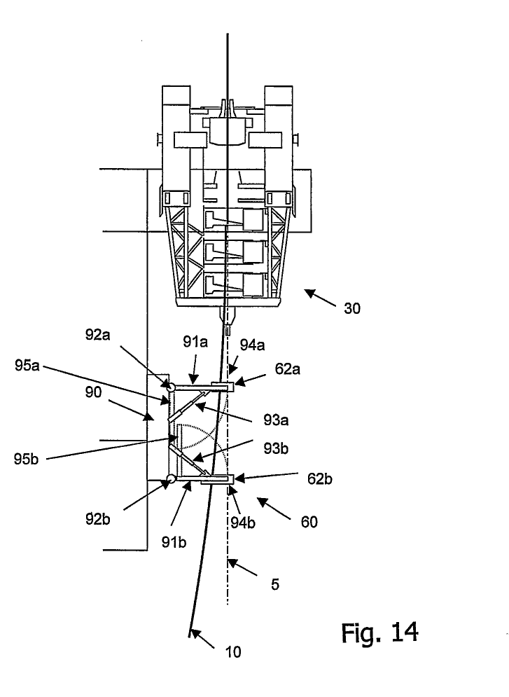

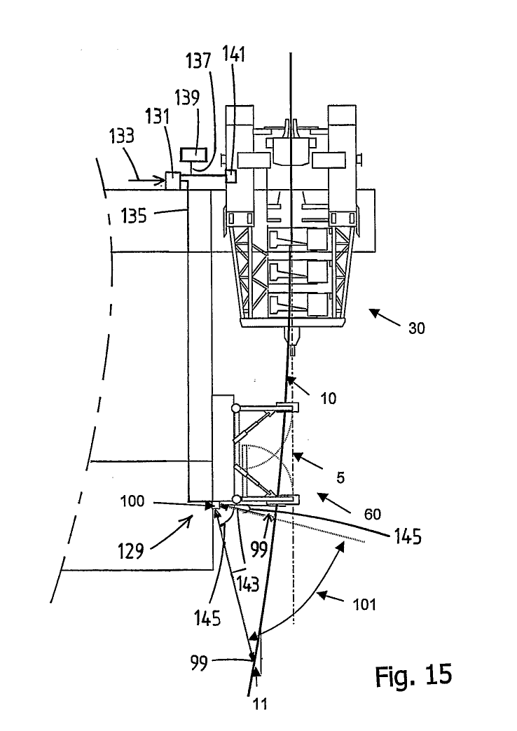

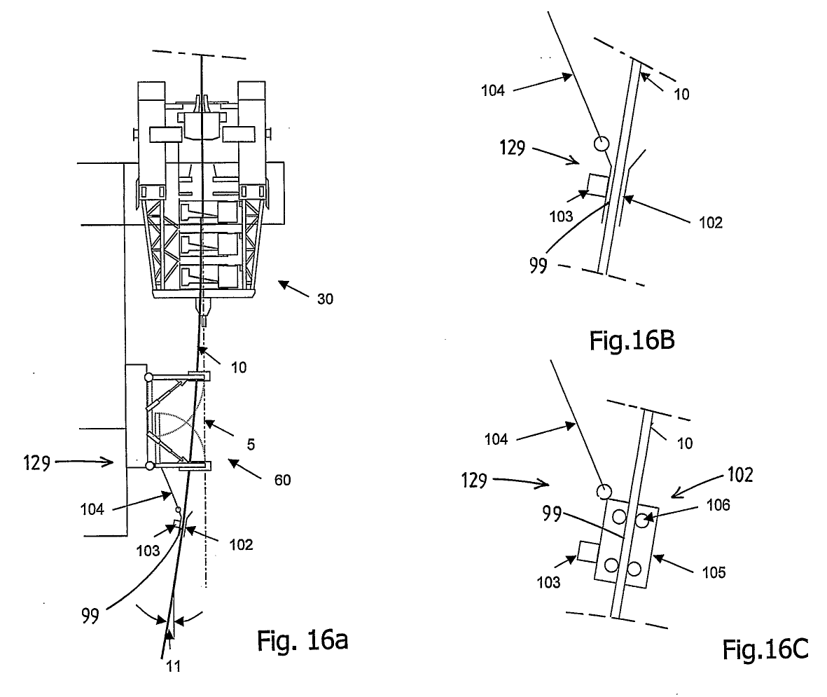

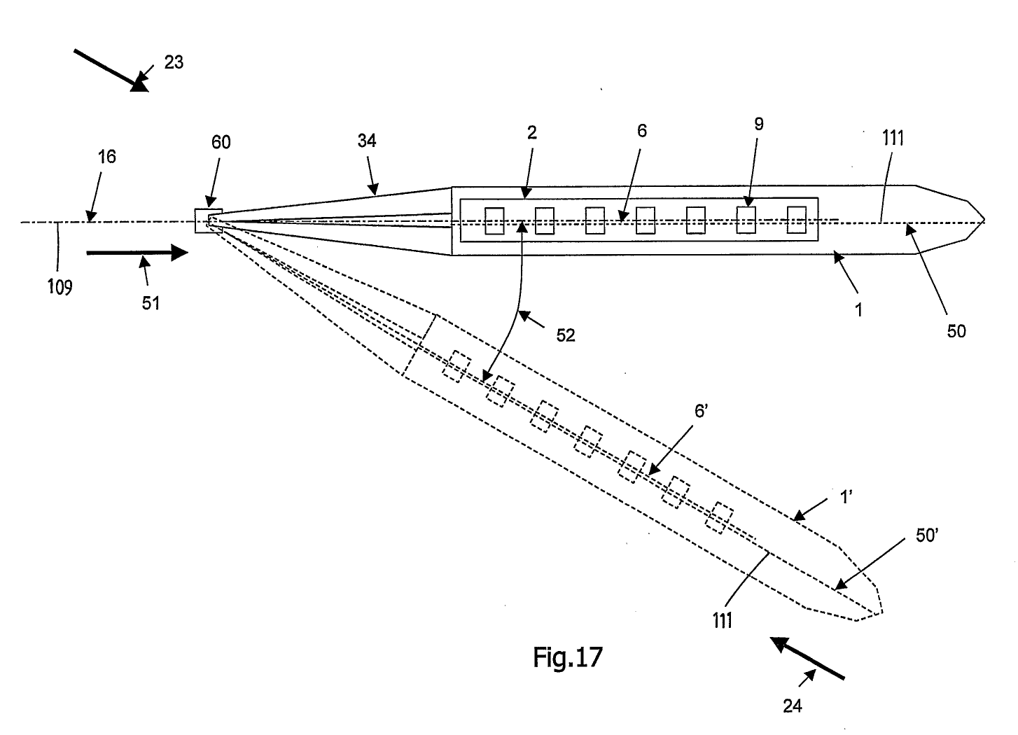

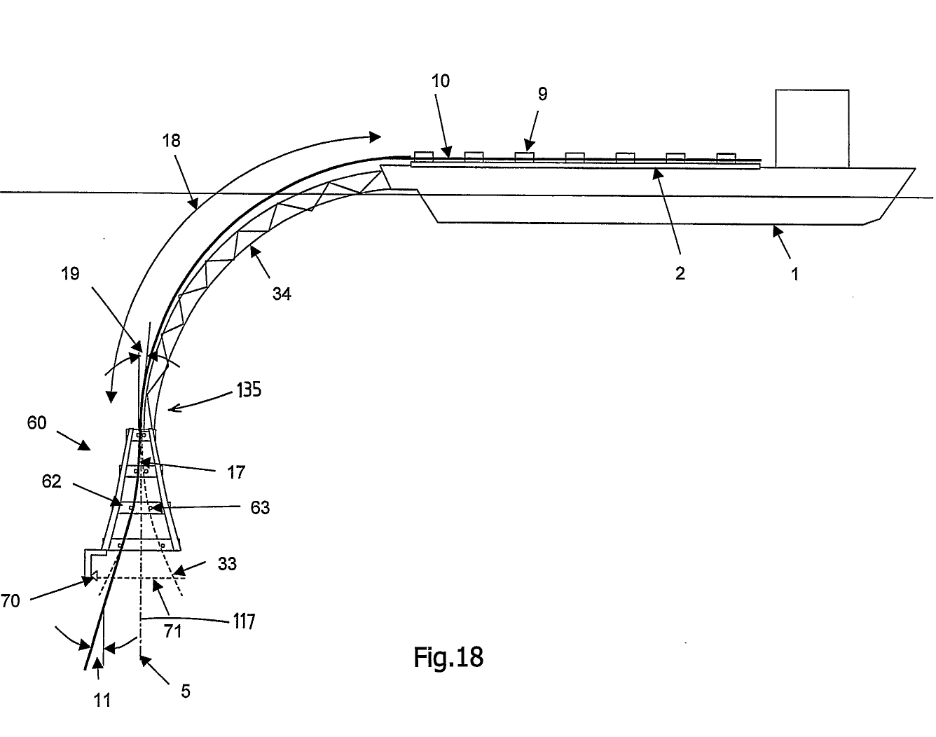

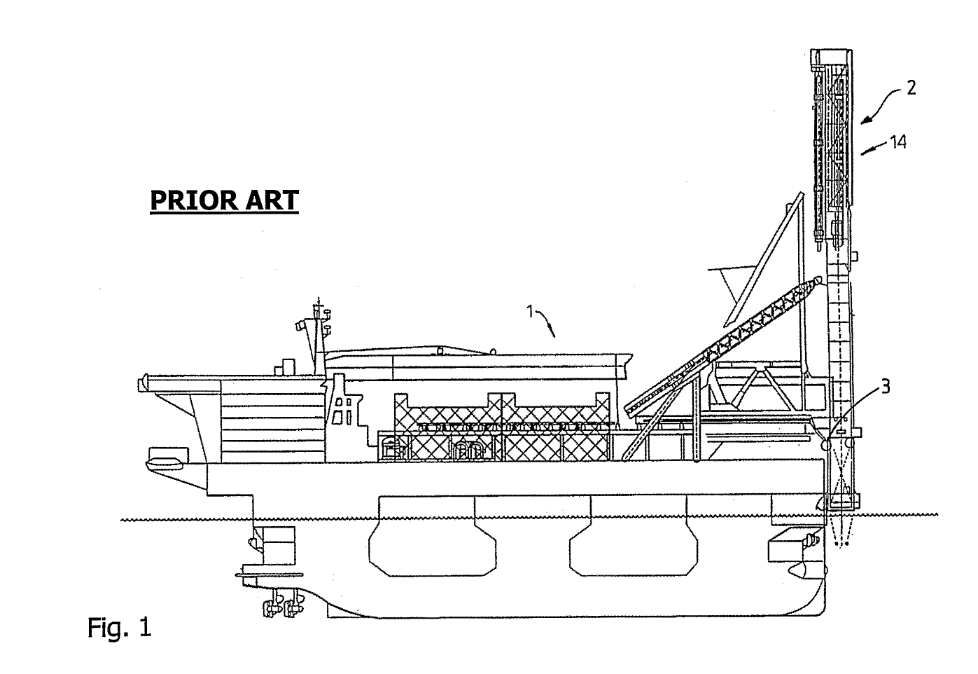

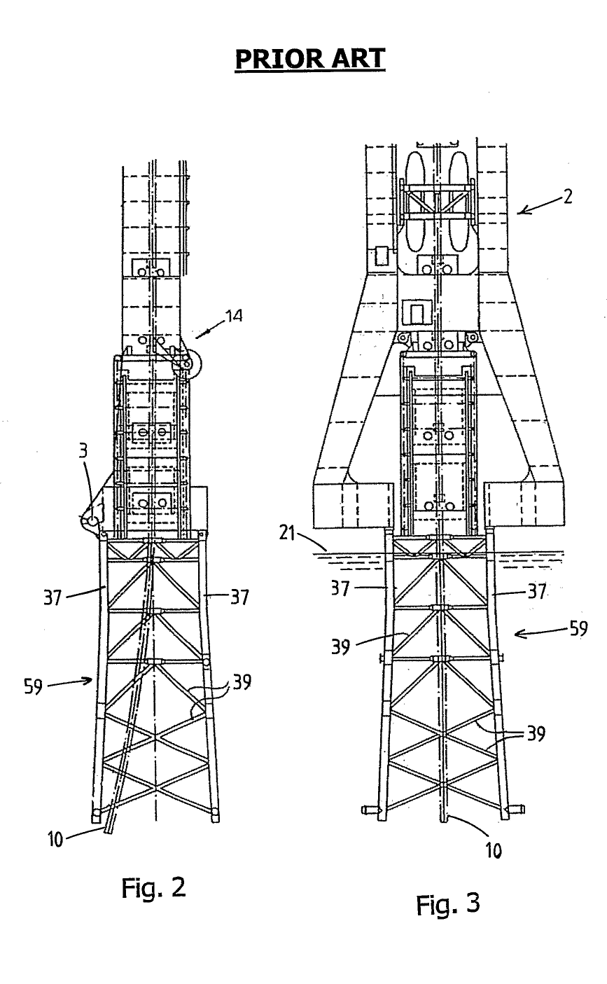

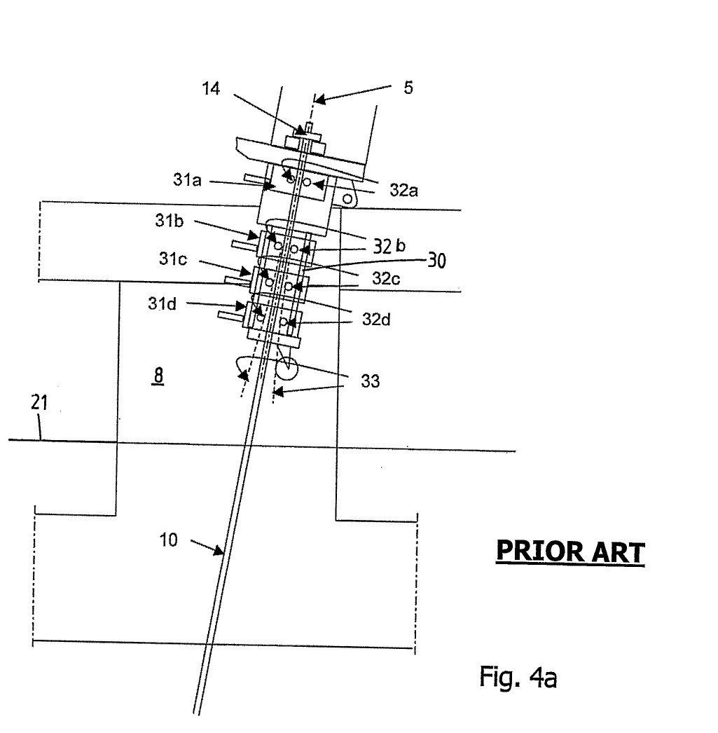

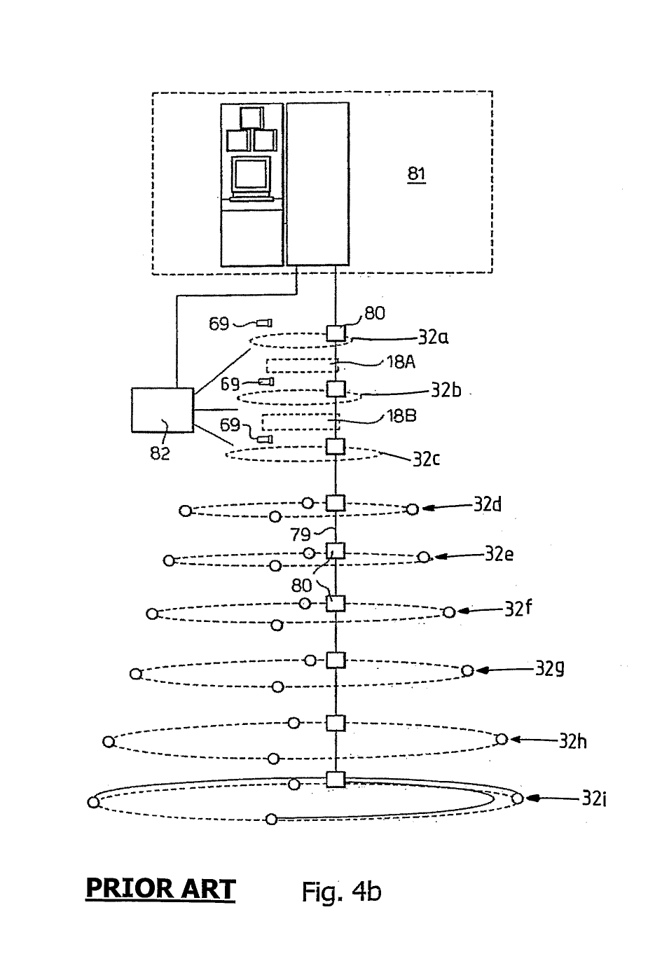

FIGS. 1, 2, 3 and 4 show a pipeline-laying vessel 1 of the prior art. The vessel 1 is provided with a tower assembly 2 defining a path down which the pipe passes as a pipeline 10 is laid by the vessel, and a lower guide arrangement 59 for guiding the pipeline 10 after it has passed down the tower assembly 2. The lower guide arrangement 59 is formed by members 37, 39. The lower guide arrangement 59 includes a plurality of sets of guide rollers 32a-32d in FIGS. 4a and 32a-32i in FIG. 4b, which are spaced apart along the path of the pipeline 10 and define the lateral limits of the path. The guide rollers are located such that they allow restricted bending of the pipeline 10.

The tower assembly 2 of the prior art is pivotably connected to the hull of the pipeline-laying vessel 1 by means of a hinge connection 3. The hinge connection 3 allows the angle 4 of the tower assembly 2 to be adjusted to a departure angle of the pipeline 10.

With reference to FIG. 4a, the lower guide arrangement 59 according to the prior art comprises a plurality of roller boxes 31a, 31b, 31c, 31d which each consist of a set of rollers 32a, 32b, 32c, 32d which are equally spaced around the circumference of the pipeline 10.

The rollers 32 are positioned at a radial distance from the longitudinal axis 5 of the tower assembly 2, the radial distance increasing as the distance between the roller box and the pipeline hang-off point 14 increases. In this way, the sets of rollers 32a, 32b, 32c, 32d together form a trumpet-like opening 33, limiting the bending moment in the pipeline 10 near the pipeline hang-off point 14 and in the transition curve supported by the rollers 32a-32d. The strain in the outer region of the pipeline is generally limited to 0.18%.

With reference to FIG. 4b, load cells are associated with each of the sets of guide rollers 32a-32f and signals from the load cells are passed back to a control station 81 via a cable 79. Signals from the load cells can be used by an operator to alter the pipe laying operation or adjust the thrust or direction of travel of the vessel 1.

A disadvantage of the vessel 1 of the prior art is that the long and heavy lower guide arrangement 59 on the bottom of the tower assembly 2 exerts high forces and bending moments on the tower assembly. Another disadvantage is that the measurement of forces by the load cells under water is difficult. A further disadvantage of the known art is that the lower guide arrangement 59 is closed, which makes it impossible to take the pipeline 10 sideways out of the lower guide arrangement 59 for instance for the installation of in-line structures.

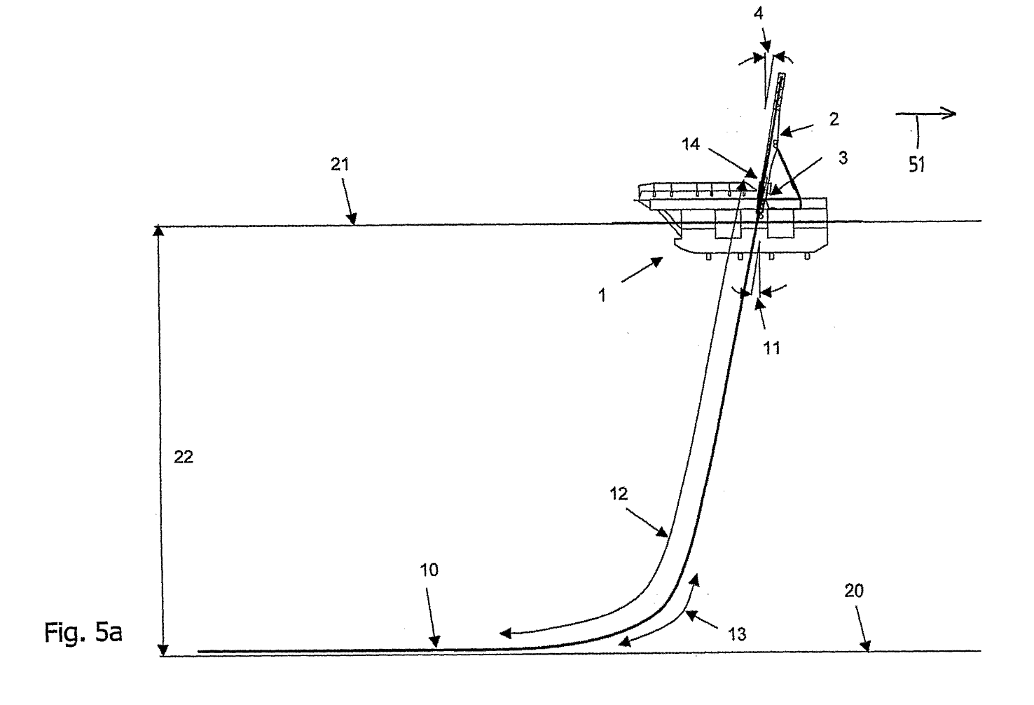

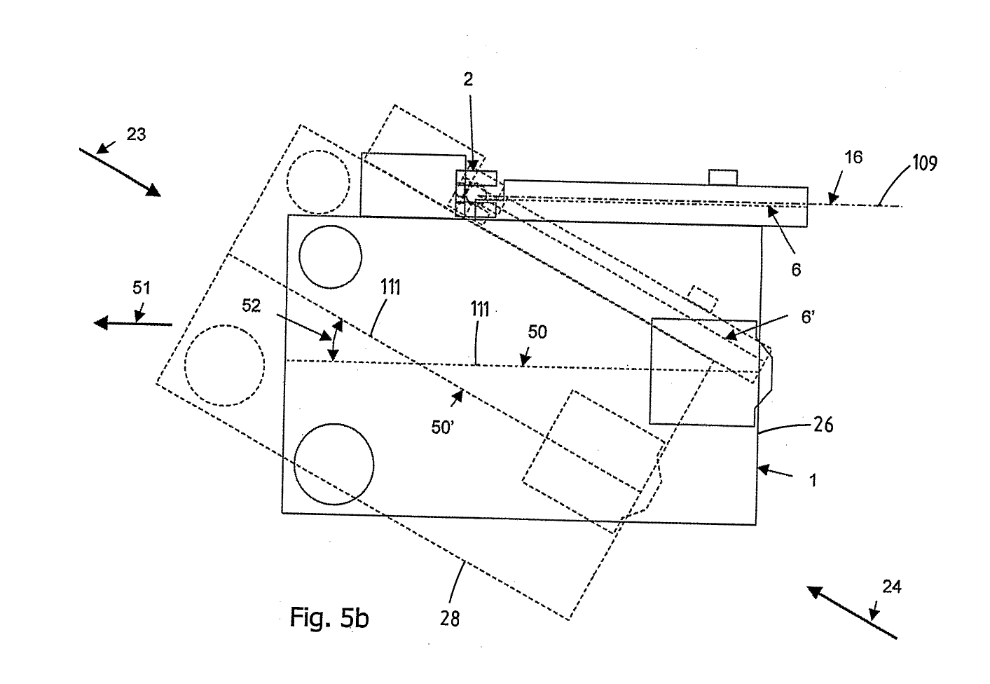

With reference to FIG. 5a, a frequently occurring situation in pipeline laying operations is shown. The pipeline section between a seabed 20 and the support point 14 on the pipeline-laying vessel 1 extends in the form of a catenary 12. The strains that occur in a so-called sag bend section 13 of the catenary 12 near the seabed 20 should not exceed a specified maximum level (e.g. 0.15%), and the bending moment at the pipeline support point 14 is zero. The stresses in the catenary 12 are kept under control by means of the thrust of the vessel exerting a horizontal force at the support point 14. The departure angle 11 of the pipeline 10 is determined by the weight of the pipeline suspended from the support point 14 and the thrust. This method of laying a pipeline 10 is called J-Lay, as the pipeline 10 extends substantially in the form of a J between the pipeline hang-off point 14 and the seabed 20. The tower assembly 2 is inclined at inclination angle 4, which is equal to the departure angle 11 of the pipeline 10.

The required thrust and thus the departure angle 11 depend primarily on the stiffness of the pipeline 10, the maximum allowable strain in the sag bend section 13 and the water depth 22. The departure angle will increase with an increasing stiffness of the pipeline, i.e. a stiff pipeline 10 will have a relatively large departure angle 11. The departure angle will generally increase with a decreasing depth, i.e. in shallow water depth the departure angle 11 will be relatively large.

Usually, a tower assembly 2 designed for J-Lay is equipped to accommodate a departure angle 11 between 0 and 30 to 40 degrees.

In order to maintain the required departure angle, the vessel 1 exerts a forwardly directed force on the pipeline 10. The force of the vessel (or thrust) required for maintaining the departure angle 11 decreases with an increasing water depth 22. The thrust is normally provided by the vessel's Dynamic Positioning system (DP-system).

During the laying of the pipeline in J-Lay an angle 4 of the longitudinal axis 5 of the tower assembly 2 is substantially equal to the departure angle 11 of pipeline 10.

With reference to FIG. 5b, a pipeline-laying vessel 1 is shown which lays the pipeline 10 in a lay direction 51. The pipeline is laid along a projected pipeline trajectory on the seabed. The longitudinal axis 50 of the vessel 1 normally extends substantially parallel to the lay direction 51. This parallel orientation is indicated with reference numeral 26.

A vertical plane 109 extends parallel to the lay direction. Another vertical plane 111 extends parallel to a longitudinal axis 50 of the vessel 1. In the parallel orientation 26, vertical planes 109 and 111 extend parallel to one another.

Generally, the pipeline-laying vessel 1 is sensitive for currents, waves and winds 23, 24. When strong currents, waves and/or wind come in from a direction deviating substantially from the longitudinal axis 16 of the pipeline 10, it is often difficult for the DP-system to keep the vessel 1 in the required position and/or orientation. In such circumstances, it can be advantageous to rotate the vessel over an angle 52 about a vertical axis to a direction substantially parallel to the direction of currents, waves or winds 23 or 24, while at the same time being able to perform a pipeline laying operation. This rotated orientation is indicated with reference numeral 28.

When the tower assembly 2 is vertical, the tower assembly 2 and the longitudinal axis 16 of the pipeline 10 both extend parallel to the vertical plane 109, despite the rotation of the vessel 1. This plane 109 extends at an angle relative to the vertical plane 111. This situation is referred to as ‘vertical lay’. In ‘vertical lay’, the pipeline 10 extends along a 2-dimensional transition curve 17 in plane 111 in order to curve from vertical to the departure angle 11.

When the tower assembly 2 is inclined, the tower assembly 2 and the section of the pipeline located in the tower assembly 2 extend in a vertical plane parallel to the vertical plane 111 which extends parallel to the longitudinal axis 50 of the pipeline-laying vessel 1. However, the section of pipeline 10 extending below the tower assembly 2 extends in a vertical plane 109 which extends substantially parallel to the lay direction 51. The plane 109 and plane 111 extend at an angle relative to one another. This situation is hereinafter referred to as ‘out-of-plane’ lay. In ‘out-of-plane’ lay, the pipeline 10 extends along a 3-dimensional transition curve 17 in order to curve from the tower angle 5 in plane 109 to the departure angle 11 in plane 111. When the rotation angle 52 of the pipeline-laying vessel 1 is less than 90 degrees, out-of-plane lay results in more favourable bending strains in the transition curve 17 than vertical lay, because the curvature of the pipeline 10 near the pipeline-laying vessel 1 is less, i.e. the curvature has a larger diameter.

However, the tower assembly 2 generally is pivotable relative to the hull in one direction only, i.e. pivotable in a forward direction and not in a backward direction relative to the lay direction 51. Thus, when the angle of rotation 52 of the pipeline-laying vessel 1 is more than 90 degrees, vertical lay generates more favourable bending strains in the transition curve 17 than out-of-plane lay.

The radius of the transition curve 17 between the section of pipeline 10 extending in the direction of the longitudinal axis 5 of the tower assembly 2 and the section of pipeline 10 extending in the vertical plane 109 is determined by the maximum allowable bending strain in this transition curve 17.

This strain can be e.g. 0.18%. This means that for larger pipe diameters in relatively shallow water the transition curve 17 may have a substantial length. In order to prevent overstraining of the pipeline 10 in the transition curve 17, it is preferably supported laterally over at least a part of the length of this transition curve 17. A pipeline guiding assembly for performing this function thus also generally has a substantial length.

Most existing pipeline construction ramps 2 designed for J-Lay have a short lower guide arrangement 30 allowing only pipe with a small diameter and a small departure angle 11 to be laid in vertical lay or out-of-plane lay. For larger pipes with a larger departure angle 11, a longer and wider lower guide arrangement is required.

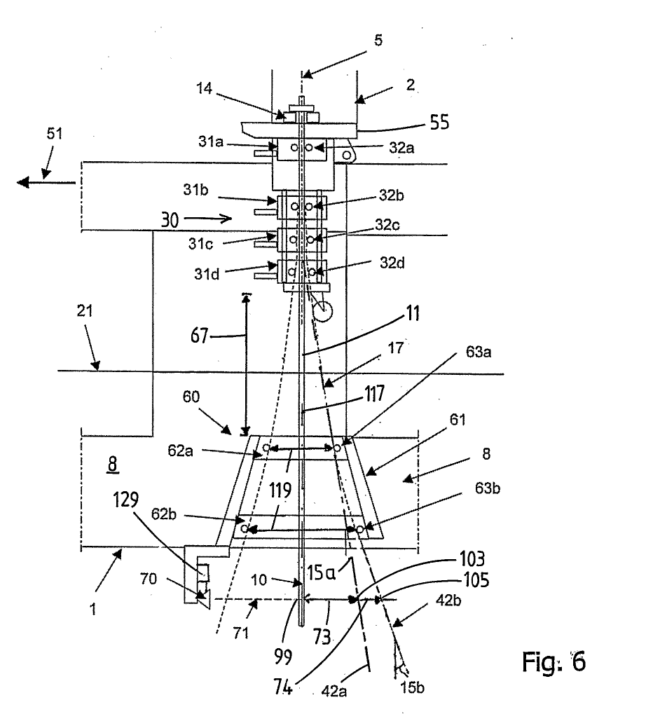

With reference to FIG. 6, a pipeline guiding assembly 60 according to the invention is provided on an underwater section of the hull assembly 8 of the pipeline-laying vessel 1. The pipeline guiding assembly 60 is provided at a distance 67 from the lower end 55 of the tower assembly 2. This distance is preferably between about 10 and 15 meter. The pipeline guiding assembly 60 is not coupled to the tower assembly 2, but connected directly ot the hull assembly 8.

The tower assembly has a longitudinal axis 5 defined by the firing line along which the pipeline 10 is advanced at the tower assembly 2. The tower assembly 2 comprises a lower guide arrangement 30 connected at a lower end 55 of the tower assembly 2, the lower guide arrangement 30 configured for laterally supporting a first part of the transition curve 17 of pipeline 10. A small portion of the horizontal forces exerted by the pipeline 10 on the vessel 1 may thus be applied to the tower assembly 2.

The pipeline guiding assembly 60 is configured to guide and support the pipeline 10 over the remaining length of the transition curve 17. The pipeline guiding assembly 60 comprises support means 63a, 63b spaced apart along a central axis 117 of the pipeline guiding assembly 60. The support means 63a, 63b each define a respective aperture 119, wherein the combined apertures define a passageway 121 for the pipeline 10. The support means 63a, 63b is configured to receive a force, in particular a horizontal force, exerted on it by the pipeline 10. Thus, the pipeline guiding assembly 60 is configured to transfer the greater part of the force directly to the hull assembly 8 while only a small part of the force affects the tower assembly 2. The pipeline is allowed to move more or less freely within the lateral limits of the passageway 121. The passageway 121 widens in a downward direction.

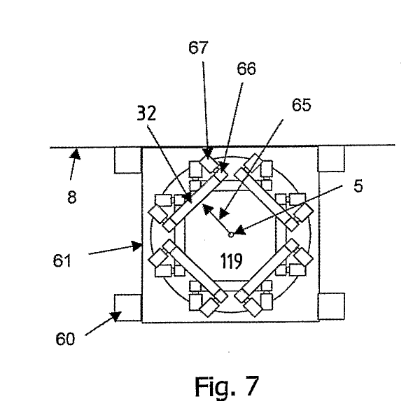

With reference to FIG. 7, the pipeline guiding assembly 60 comprises a roller box support structure 61 comprising roller boxes 62a, 62b. The support means 63a, 63b are formed by roller sets 63a, 63b, which can be positioned at a predetermined, relatively wide radius 65 with respect to the central axis of the pipeline guiding assembly. Each roller set 63a, 63b comprises a number of rollers 32 which together define the lateral limits of the aperture 119 around the central axis 117. The radius 65 (or distance) at which the rollers 32 can be positioned from the central axis 117 and the distance 67 below the bottom of the lower guide arrangement 30 at which the pipeline guiding assembly 60 is positioned allow the pipeline 10 to adopt a transition curve 17 from the orientation of the tower assembly 2 to the pipeline axis 16 which extends in vertical plane 109.

The transition curve 17 generally has a relatively large radius. Thus, vertical-lay or out-of-plane lay for large diameter pipe is enabled in relatively shallow water depth 22.

Referring to FIG. 6 again, at the lower end of the pipeline guiding assembly 60, at a distance below the lowermost roller box 62b, a pipeline measuring device 129 is provided comprising a sensor 70, which sensor 70 measures a position of pipeline 10 in a plane 71 which extends substantially perpendicular to the central axis 117 of the pipeline guiding assembly 60. On the basis of analysis of the relationship between occurring strains in the pipeline, in particular in an outer layer of a wall of the pipeline 10, an allowable minimum departure angle 15a and an allowable maximum departure angle 15b or an allowable inner position 103 and an allowable outer position 105 are determined, the allowable minimum and maximum departure angles or the allowable inner and outer positions defining the range within which the measured pipe angle or measured pipe position should stay. The allowable minimum departure angle 15a or the allowable inner pipe position 103 are determined by the maximum allowable strain in the sag bend section 13, which may be 0.15%. The allowable maximum departure angle 15b or the allowable outer pipe position 105 are determined by the maximum allowable reaction force of any of the rollers 32 on the pipeline 10, or by the maximum bending strain in pipeline 10 in the transition curve 17 (e.g. max. 0.18%), or by a combination thereof. If the reaction force of the rollers 32 on the pipeline exceeds a certain limit, local deformation or damage of the pipeline may occur.

The position of the pipeline may either be determined by directly measuring a position of a point on the pipeline relative to a known point on the vessel or by measuring the inclination of the pipeline in one or more locations and by determining the position of the pipeline on the basis of the measured inclinations.

In FIGS. 6, 15 and 16, alternative embodiments of the pipeline measuring system are shown.

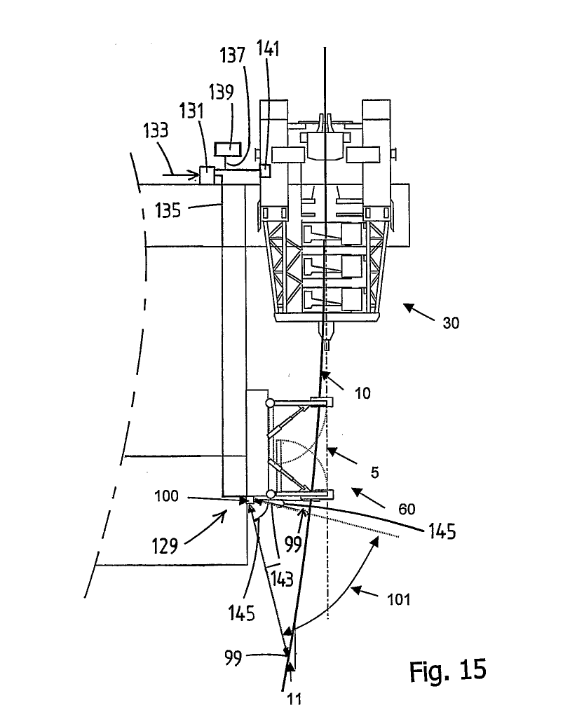

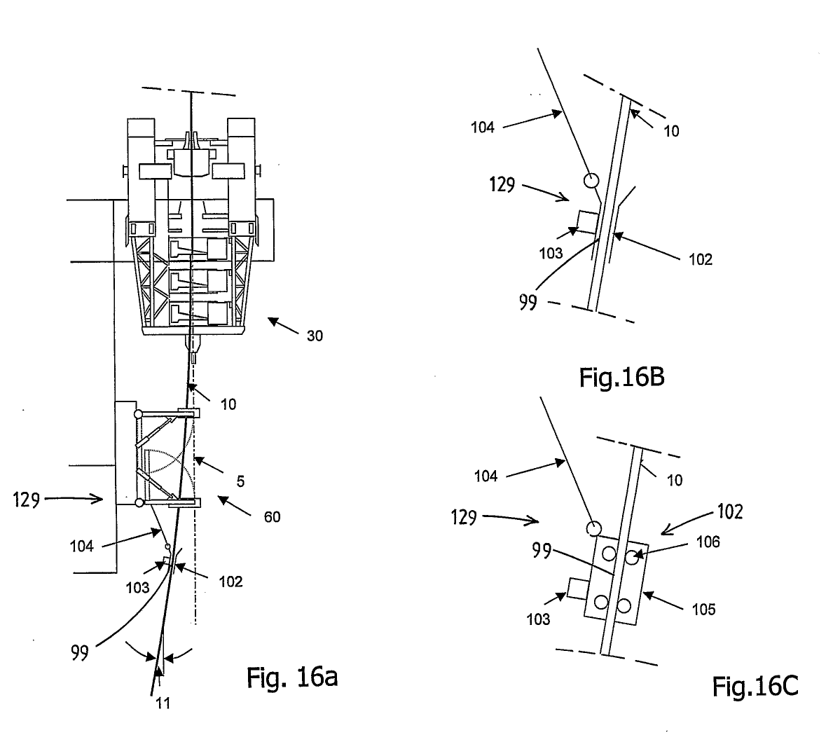

In FIG. 6, the measuring sensor 70 is a 2-dimensional sensor which measures the position of the pipe in plane 71. In operation, the pipeline laying process is controlled such, that this position stays between the allowable inner and outer positions as determined from pipelay analysis. In FIG. 15, the 3-dimensional sensor 100 measures multiple positions of the pipe in a 3-dimensional sensing zone 101. From the measured pipe positions, a departure angle 11 of the pipeline 10 can then be calculated. In operation, this departure angle 11 stays between the allowable minimum and maximum departure angles as determined from pipelay analysis. In FIG. 16, an inclinometer 103 measures directly the departure angle 11. In operation, it is ensured that this departure angle 11 stays between the allowable minimum and maximum departure angles as determined from pipelay analysis.

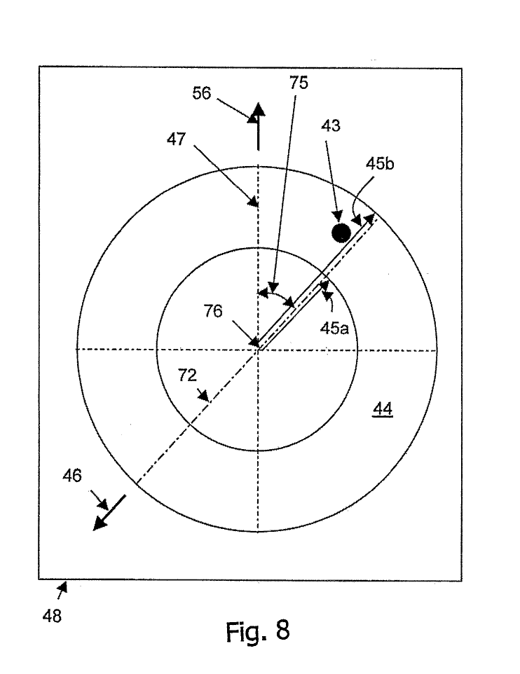

FIG. 8 shows a display of allowable displacements of the pipeline at the level of plane 71 in FIG. 6. The display may be created on a screen in order to allow operators to control the pipeline position. Plane 71 extends substantially perpendicular to the central axis 117. The pipeline position as measured by sensor 129 is shown on the display 48 as pipe position 43. The pipe position 43 is allowed to move within a watch ring 44, the inner radius 45a and outer radius 45b of which are determined by the values of the allowable inner pipe position 103 and outer pipe position 105 in plane 71 respectively. The center 76 of the watch ring 44 is determined by the value of the intersection point 99 of the axis 117 of the pipeline guiding assembly 60 and the plane 71. The watch ring 44 is determined from analysis of the pipelay process.

The display shows the heading of the pipeline relative to the heading of the vessel as follows. A line 72 is shown under an angle 75 with respect to the line 47, the line 47 representing the longitudinal axis 50 of the pipeline-laying vessel 1 and arrow 56 the heading of the vessel, and the line 72 representing the lay direction 51, indicated by arrow 46. The lay angle 75 is thus equal to the rotation angle 52 of vessel axis 50 with respect to the lay direction 51. Line 72 intersects line 47 at center 76 of the watch circle 44.

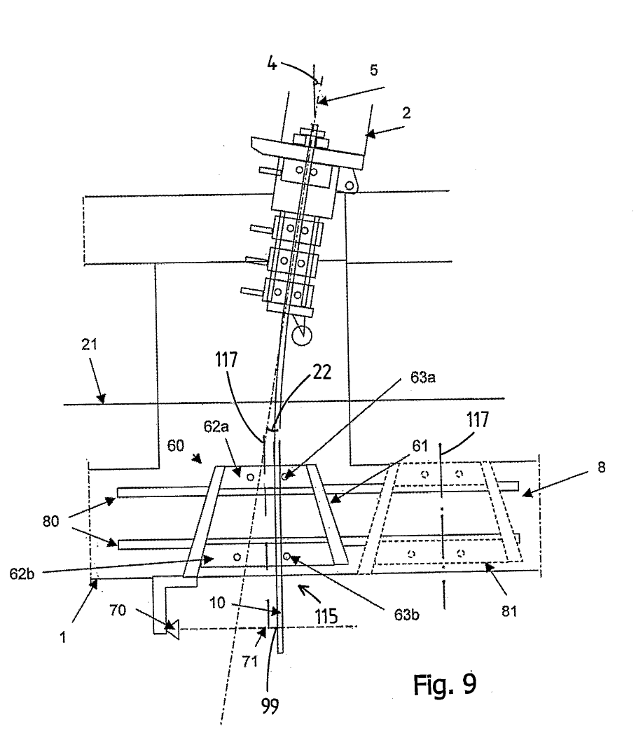

With reference to FIG. 9, a different embodiment of the invention is shown, in which the pipeline guiding assembly 60 is mounted on a horizontal rail device 80 attached to an underwater section 8 of the pipeline-laying vessel 1. The rail device 80 makes it possible to support the pipeline 10 when laying pipeline in out-of-plane lay with the tower assembly 2 inclined at an inclination angle 4 and the vessel rotated over a substantial angle 52 with respect to the lay direction 51. The pipeline guiding assembly 60 is then moved along the rail device 80 relative to the hull assembly to position 115. In position 115, the inclined tower axis 5 extends through the passageway 121 defined by the roller boxes 62a, 62b.

The rail device 80 also makes it possible to move the pipeline guiding assembly 60 away from the longitudinal axis 5 of the tower assembly to a retracted position 81, in order to enable the installation of large in-line structures in the pipeline 10 at the tower assembly 2, and to allow the in-line structures to pass downwards, past the pipeline guiding assembly 60.

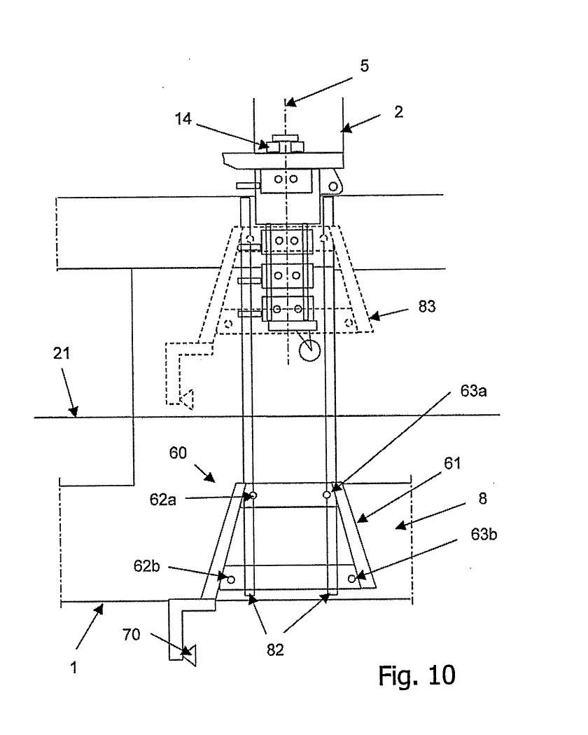

With reference to FIG. 10, an embodiment is shown wherein the pipeline guiding assembly 60 is mounted on a vertical rail device 82 attached to the pipeline-laying vessel 1. The vertical rail device 82 makes it possible to move the pipeline guiding assembly 60 above the waterline 21 to a repair and maintenance position 83, where it can be repaired and maintained.

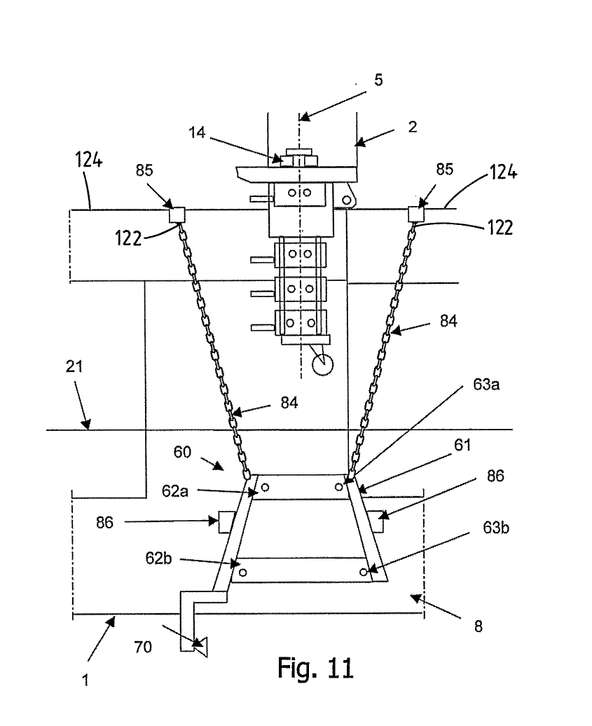

With reference to FIG. 11, an embodiment is shown wherein the pipeline guiding assembly 60 is suspended from an assembly of suspension elements (chains or slings or rods) 84, which are connected at their upper ends 122 to the deck 124 of the pipeline-laying vessel 1 by means of suspension supports 85. On the underwater section 8 of the pipeline-laying vessel 1, releasable securing supports 86 are provided to firmly secure the pipeline guiding device 60 to the pipeline-laying vessel 1 against current and wave forces. The suspension assembly 84, 85 and releasable supports 86 make it possible to remove the pipeline guiding assembly 60 when it is not needed or when it is in the way, for instance during the pipeline laying in J-Lay mode or during the installation of an in-line structure.

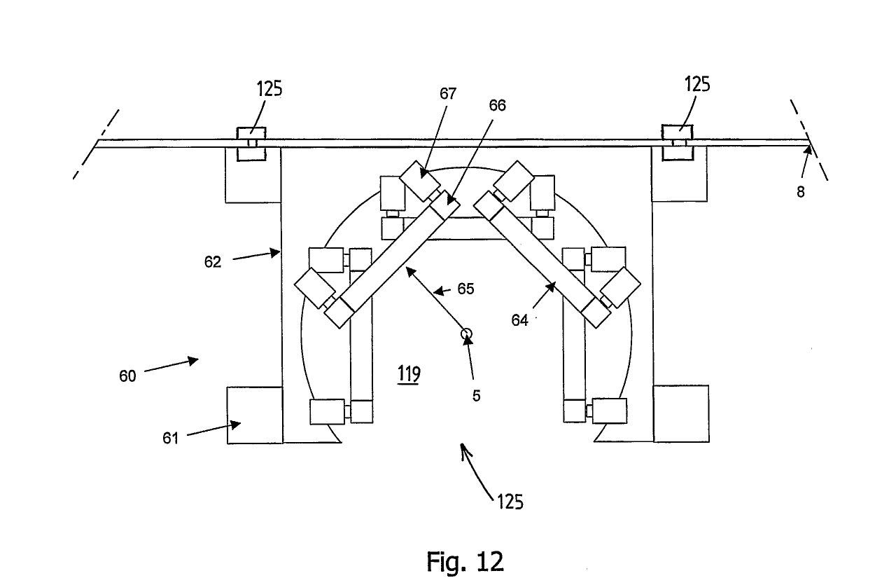

With reference to FIG. 12, an embodiment of the invention is shown comprising a pipeline guiding assembly 60 which has an opening 125 in a side thereof, i.e. having partly open roller boxes 62. The opening 125 is provided on the side facing away from the hull assembly 8 of the vessel 1. This embodiment prevents the occurrence of a pulling force on a connection 125 between the pipeline guiding assembly 60 and the underwater section 8 of the pipeline-laying vessel 1.

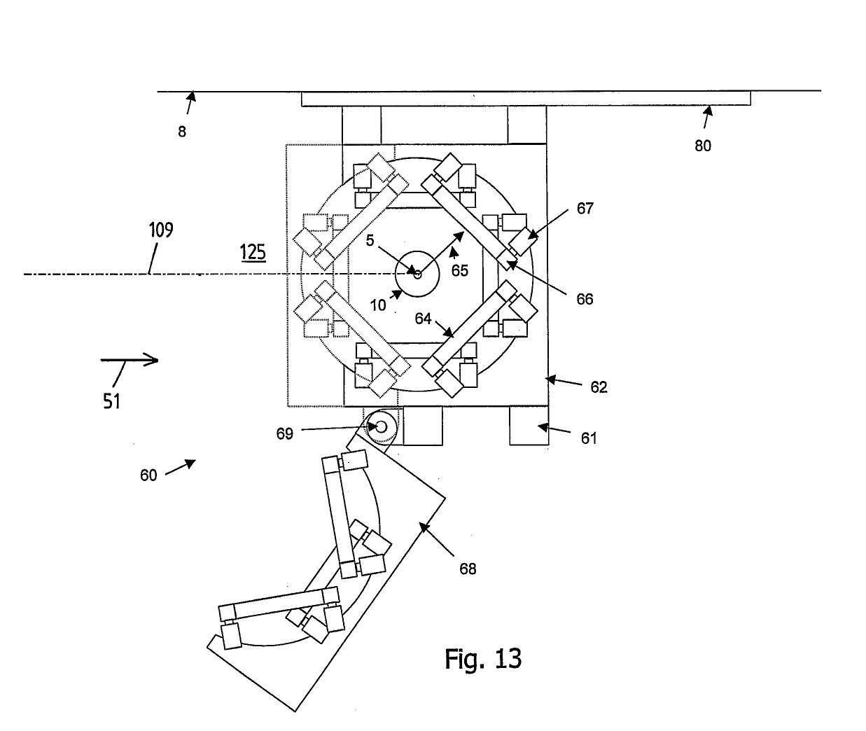

With reference to FIG. 13, a variant of the invention is shown, comprising a partly open pipeline guiding assembly 60 with partly open roller boxes 62, provided with a roller box door 68. The roller box door 68 is pivotable about a roller box hinge 69, creating an opening 125 in the side of the pipeline guiding assembly 60 which provides access to the aperture 119. When the guide assembly 60 is oriented with the opening 125 in the direction of the vessel launching path 6, the guide assembly 60 can be moved horizontally towards and away from the pipeline 10, for instance along a horizontal rail device 80 as shown in FIG. 9. Alternatively, the pipeline 10 can be moved out of the guide assembly 60 relative to the vessel 1 in the lay direction 51 for taking the pipeline sideways out of the tower assembly 2, for instance when a free end of the pipeline 10 is to be handed over to a target platform (not shown), or when an in-line structure (not shown) which has larger lateral dimensions than the aperture 119 is inserted in the pipeline 10.

Also, the guide assembly 60 can be closed around the pipeline 10 during J-Lay mode, and then be moved in the lay-direction 51 relative to the vessel 1 with the pipeline 10 when the tower assembly 2 is rotated to a vertical position or when the vessel 1 is rotated for out-of-plane lay. In this way, the guide assembly 60 causes the pipeline 10 to adopt its required curvature during the rotating of the tower assembly 2 relative to the vessel 1.

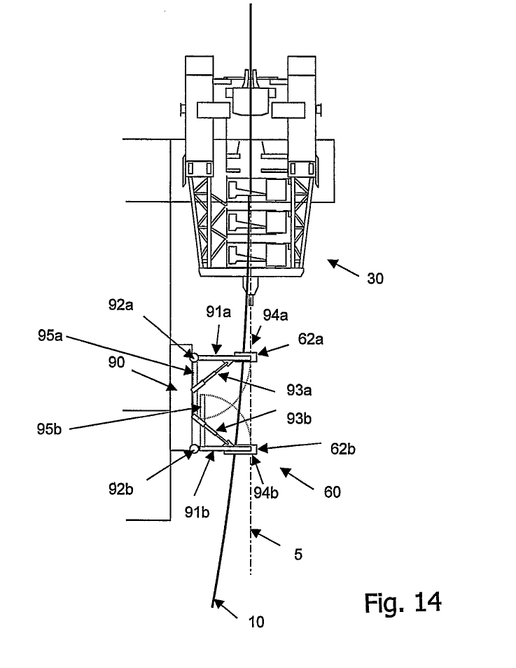

With reference to FIG. 14, the pipeline guiding assembly 60 may comprise a fixed roller box support structure 90, wherein each roller box 62a, 62b is pivotably connected to the fixed roller box support structure 90 by means of a pivotable arm 91 and a hinge 92. Each pivotable arm 92 is actuated by a roller box arm actuator 93, which pivots the roller box 62 into a guiding position 94 and to retract it therefrom into a folded position 95.

In this way, the pipeline guiding assembly 60 can be folded out of the path of an in-line structure when such a structure is installed in or on the pipeline 10 and is to be passed along the pipeline guiding assembly 60.

In FIG. 15, a pipeline measuring device 129 comprising a 3-dimensional sensor 100 is provided at the bottom side of the pipeline guiding assembly 60. The sensor 100 measures the position of the pipe in a 3-dimensional sensing zone 101. The 3-dimensional sensor 100 measures the position of the pipeline at a plurality of points 99, creating a three-dimensional image of the pipeline 10. The sensor 100 may determine the distance 143 between the sensor 100 and the respective points 99 and the angle 145 at which the distance 143 is measured. Acoustic and video sensors are known for this purpose. Hence, the departure angle 11 of the pipeline 10 can be determined more directly.

The sensor 100 may be an acoustic device. Other types of sensors may also be used.

With reference to FIGS. 16a, 16b and 16c, an embodiment is shown comprising a pipeline measuring device 129 for measuring a departure angle 11, wherein an engagement member in the form of a pipe inclinometer sleeve 102 is slidably fitted substantially around the pipeline 10 at a point below the pipeline guiding assembly 60. The pipe inclinometer sleeve 102 is suspended from the pipeline guiding assembly 60 by inclinometer suspension means 104. The inclinometer sleeve 102 carries a sensor in the form of an inclinometer 103 which measures directly the inclination of the sleeve and thus of the departure angle 11.

The inclinometer sleeve 102 may also be supported by an engagement member in the form of an inclinometer support structure 105 which is closed around the pipeline 10 and riding over the pipeline 10 on wheels 106, the inclinometer support structure 105 being suspended from the bottom-side of the pipeline guiding assembly 60 by means of inclinometer suspension means 104.

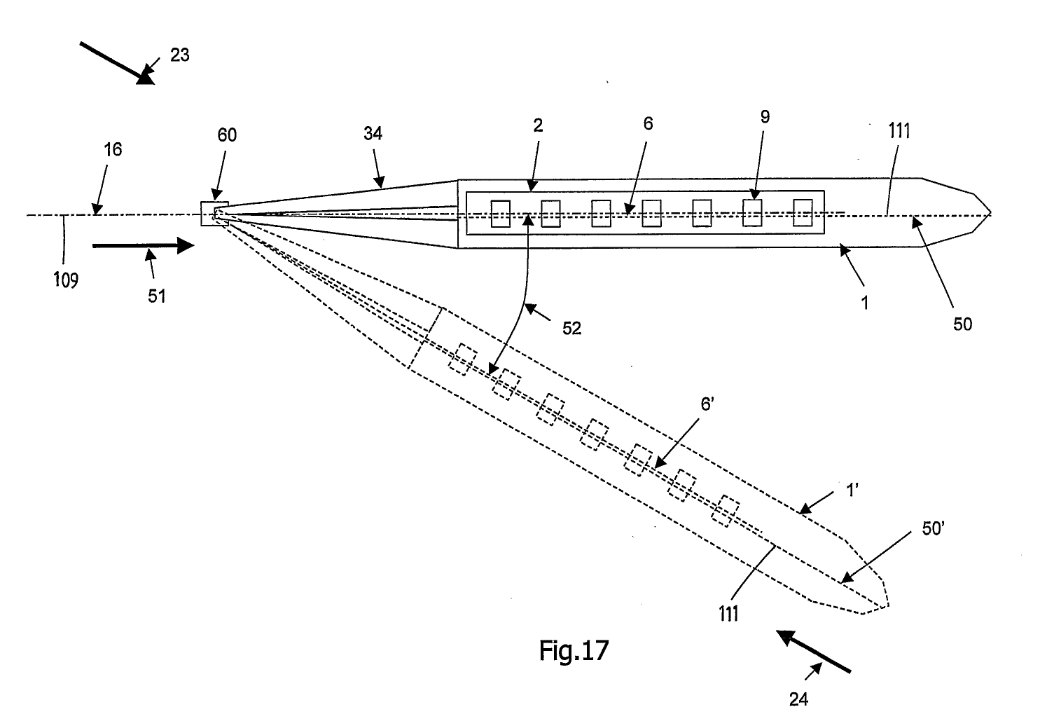

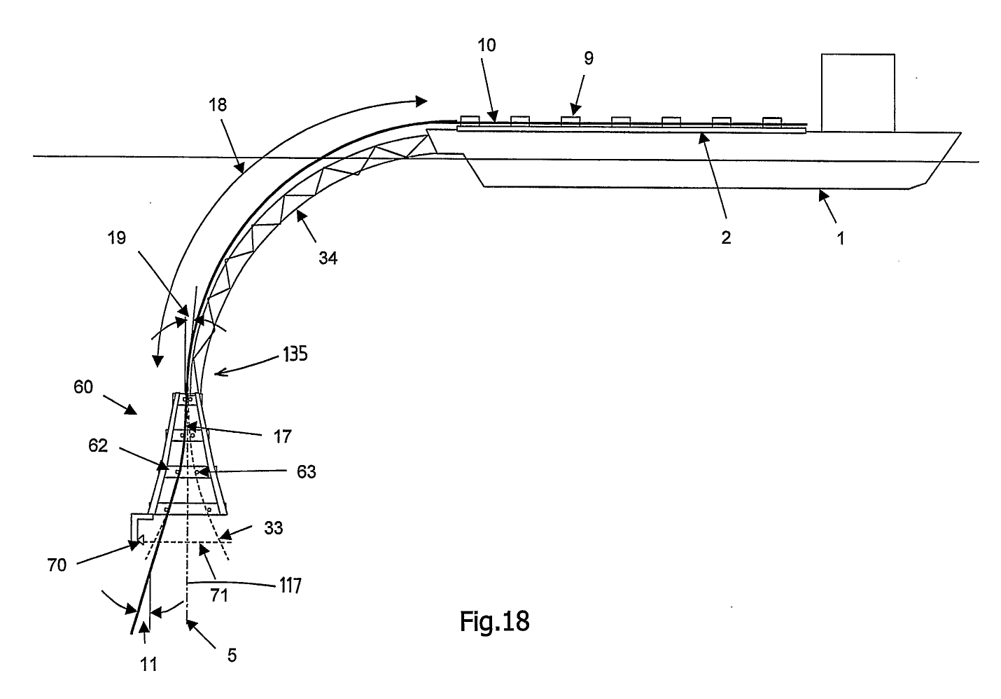

With reference to FIGS. 17 and 18, an alternative embodiment of the invention is shown wherein the pipeline guiding assembly 60 is mounted to a lower guide arrangement 34 of a pipeline-laying vessel 1 configured for laying a pipeline 10 in S-Lay mode. The pipeline 10 is constructed in a number of workstations 9 located on a horizontal pipeline construction ramp 2 on the deck of the vessel 1.

In normal S-Lay mode, the pipeline is laid in a vertical plane 109 extending parallel to the lay direction 51, which extends parallel to the longitudinal axis 50 of the vessel 1. The vessel 1 thus is oriented with its longitudinal axis 50 parallel to the longitudinal axis 16 of the pipeline and moves in the lay direction 51. The projected trajectory of the pipeline on the seabed, the longitudinal axis of the pipeline, the longitudinal axis 50 of the vessel and the direction of movement 51 of the vessel all extend parallel to one another.

An S-Lay vessel 1 is also sensitive to currents, waves and winds coming in from a direction which is substantially different than its longitudinal axis 50, making it difficult for the DP-system to keep the vessel in the required position in such conditions. When the current or the wind comes in from a direction deviating substantially from the longitudinal axis 50 of the vessel, a need exists to rotate the vessel 1 away from the lay direction 51 to a direction substantially parallel to the direction of the current, waves or winds 23, 24.

As shown in FIG. 18, a deepwater S-Lay vessel 1 is equipped with a lower guide arrangement 34 configured to support an over-bend 18 of the pipeline 10 from the horizontal orientation on the construction ramp 2 to the departure angle 11, which can be close to 0 degrees.

When the vessel 1 is to be rotated about a vertical axis to an orientation parallel to the direction of current and wind 23, 24, the pipeline 10 makes a transition curve 17 from the angle of the lower guide arrangement tip 19 in plane 111 to the departure angle 11 in the vertical plane 109 extending through the projected trajectory. A pipeline guiding assembly 60 is mounted at the tip (or free end) of the lower guide arrangement 34, the pipeline guiding assembly 60 having a number of roller boxes 62 of which the roller sets 63 can be positioned at a distance relative to a central axis 117 to form a trumpet-like opening 33. The trumpet-like opening 33 prevents overstraining of the pipeline 10 in the transition curve 17, the maximum allowable strain in the transition curve 17 being e.g. 0.18%.

A pipeline measuring device 129 is provided at the bottom-side of pipeline guiding assembly 60, comprising a sensor 70 for measuring the position of pipeline 10 in the measuring plane 71 or a sensor 100 or 103 for measuring the departure angle 11 directly as described with reference to FIGS. 8 and 15.

It will be obvious to a person skilled in the art that numerous changes in the details and the arrangement of the parts may be varied over considerable range without departing from the spirit of the invention and the scope of the claims.

1. A pipeline-laying vessel comprising:
a hull assembly for providing buoyancy to the pipeline-laying vessel;
a tower assembly extending upwardly from the hull assembly for supporting a part of the pipeline which is to be laid; and
a pipeline guiding assembly provided at a position below the tower assembly and configured to guide the pipeline,
wherein the pipeline guiding assembly is coupled to the hull assembly for transferring a force exerted by the pipeline on the pipeline guiding assembly to the hull assembly.

2. The pipeline-laying vessel of claim 1, wherein the pipeline guiding assembly defines a space in which the pipeline can move laterally, the space widening in a downward direction, in particular in the form of a trumpet-shape.

3. The pipeline-laying vessel of claim 1, wherein the pipeline guiding assembly is provided at a distance below a lower end of the tower assembly.

4. The pipeline-laying vessel of claim 1, wherein the pipeline guiding assembly comprises a plurality of support means spaced apart from one another in a substantially vertical direction, each support means being configured to receive a force exerted on it by the pipeline.

5. The pipeline-laying vessel of claim 4, wherein each support means defines a respective aperture which substantially surrounds the path of the pipeline.

6. The pipeline-laying vessel of claim 1, wherein the tower assembly is pivotably mounted relative to said hull assembly.

7. The pipeline-laying vessel of claim 1, further comprising a pipeline measuring device comprising a sensor, the pipeline measuring device being configured for measuring:
a departure angle at which the pipeline extends relative to a longitudinal axis of the tower assembly of at least one point on the pipeline, and/or
a location of a point of the pipeline relative to a known point on the vessel.

8. The pipeline-laying vessel of claim 7, wherein the pipeline measuring device is configured to perform a measurement on a point on the pipeline at a lower end of the pipeline guiding assembly.

9. The pipeline-laying vessel of claim 7, wherein the pipeline measuring device comprises a control unit comprising:
a first input for receiving departure angle data and/or position data relating to an allowable departure angle and/or allowable position of the pipeline respectively and
a second input configured to receive an input signal from the sensor relating to the measured point, the control unit being configured to compare the signal with the allowable departure angle data and/or position data and to generate an output signal on the basis of the comparison;
an output for outputting the output signal; and
a display means for displaying the output signal to an operator or a control means configured for controlling at least one parameter of the pipeline laying process on the basis of the output signal.

10. The pipeline-laying vessel of claim 7, wherein the sensor is provided on an engagement member configured to be in contact with the pipeline, the engagement member configured to allow the pipeline to move relative to the engagement member in the direction of the main longitudinal axis of the pipeline.

11. The pipeline-laying vessel of claim 1, wherein the pipeline guiding assembly is movable relative to the hull assembly in a horizontal direction.

12. The pipeline-laying vessel of claim 1, wherein the pipeline guiding assembly is movable relative to the hull assembly in a vertical direction.

13. The pipeline-laying vessel of claim 1, wherein the pipeline guiding assembly is pivotable relative to the hull assembly about a substantially horizontal axis.

14. The pipeline-laying vessel of claim 1, wherein the pipeline guiding assembly is movable away from the launching path in order to allow an in-line or add-on structure of the pipeline to pass by the pipeline guiding assembly.

15. The pipeline-laying vessel of claim 1, wherein the pipeline guiding assembly is removably attached to the hull assembly.

16. The pipeline-laying vessel of claim 1, wherein the pipeline guiding assembly is suspended from the pipeline-laying vessel by at least one elongate suspension member.

17. The pipeline-laying vessel of a claim 1, wherein the pipeline guiding assembly comprises a cut-away section allowing a pipeline to be moved substantially laterally into and/or out of the space defined by the pipeline guiding assembly.

18. The pipeline-laying vessel of claim 17, wherein the pipeline guiding assembly further comprises a door device, for opening and/or closing the cut-away section.

19. The pipeline-laying vessel of claim 1, wherein the pipeline guiding assembly comprises a plurality of roller devices.

20. The pipeline-laying vessel of a claim 1, wherein each of the support means is pivotably mounted to the hull assembly or to a support structure mounted to the hull section allowing each support means to be pivoted away from a central axis of the pipeline guiding assembly.

21. A pipeline-laying vessel configured for S-lay, the pipeline-laying vessel comprising a support structure which extends downward from the hull assembly, wherein a pipeline guiding assembly is fitted at a lower end of the support structure, the pipeline guiding assembly comprising a plurality of support means spaced apart along a central axis of the pipeline guiding device in the form of a trumpet-shape, the support means configured for supporting the pipeline in a lateral direction.

22. A method of laying a pipeline, comprising providing a pipeline-laying vessel comprising:
a hull assembly for providing buoyancy to the pipeline-laying vessel;
a tower assembly extending upwardly from the hull assembly for supporting a part of the pipeline which is to be laid; and
a pipeline guiding assembly provided at a position below the tower assembly and configured to guide the pipeline,
wherein the pipeline guiding assembly is coupled to the hull assembly for transferring a force exerted by the pipeline on the pipeline guiding assembly to the hull assembly,
wherein during the laying of the pipeline, the pipeline is laterally supported by the pipeline guiding assembly.

23. The method of claim 22, wherein during the laying of the pipeline, the pipeline-laying vessel is rotated about a vertical axis relative to a lay direction, such that a longitudinal axis of the pipeline laying vessel extends at an angle to the lay direction.

24. The method of claim 22, wherein the longitudinal axis of the tower assembly extends vertically during the laying of the pipeline.

25. The method of claim 22, wherein the longitudinal axis of the tower assembly extends at an angle to a vertical axis during the laying of the pipeline.

26. A vessel for laying a pipeline, comprising:
a pipeline construction ramp provided on board the vessel for connecting respective pipe members to the pipeline;
a support structure for laterally supporting the pipeline as it is launched from the vessel, the support structure being connected to the pipeline construction ramp; and
a pipeline measuring system configured to determine an angle of the longitudinal axis of a pipeline section extending downward from the pipeline laying vessel relative to a vertical axis and/or configured to measure a location of a point on the pipeline section relative to a known point on the vessel.

27. The vessel of claim 26, wherein the pipeline measuring system comprises an engagement member which is configured to engage the pipeline section, the engagement member comprising at least one sensor for determining the pipeline angle, the engagement member configured to allow a downward movement of the pipeline relative to said engagement member.
